(19) United States
(12) Patent Application Publication
(10) Pub. No.: US 2012/0059663 A1
(43) Pub. Date: Mar. 8, 2012

(54) METHODS AND APPARATUS FOR PATIENT VISIT WORKFLOW

(76) Inventors: Kate Levesque, Littleton, MA (US); Mary C. Foley, Cambridge, MA (US); John Michael German, Waltham, MA (US); Brady Richards, Allston, MA (US); Justin Seger, Belmont, MA (US); Ryan Wise, Allston, MA (US)

(21) Appl. No.: 12/875,578

(22) Filed: Sep. 3, 2010

(51) Int. Cl. G06Q 50/00

(52) U.S. Cl. 705/2

(57) ABSTRACT

Methods and apparatus for facilitating the collection of information during a patient visit to a healthcare provider. Each of plurality of tasks to be performed during a patient visit are associated with a stages of the patient visit. One or more users are guided through the stages of the patient visit to complete the associated tasks associated with each stage. A user interface associated with an electronic health records system displays pages for each stage that enable the users to enter information during the patient visit. The amount of time that users spend entering information in the electronic health records system during each stage is tracked and is used to generate one or more reports that enable a medical practice to improve the patient visit workflow.

### BACKGROUND

With the advent of electronic health records (EHRs) and electronic medical billing, many healthcare providers have adopted procedures to enter most (or all) incoming information into one or more computer databases so that the information may be readily accessible to doctors, nurses, or other clinical staff who require it. The increased accessibility of patients' medical information afforded by EHRs is just one of several factors which provide improvements over more conventional paper-based data management systems. For example, provided such data is accompanied by appropriate security measures, data stored in EHRs may be more conveniently copied to another location for backup purposes, and EHRs may be more easily transferred from one hospital or clinic to another than traditional paper-based medical files. Yet another potential advantage of EHRs is the ability to store large quantities of data from a variety sources, including laboratory results, imaging results, medical histories, etc. in a cohesive manner.

### SUMMARY

Although the adoption of EHRs by healthcare providers has resulted in a health information system that is more flexible than conventional paper-based systems, there is often a perception that EHRs slow physicians down by requiring them to enter health data in a manner in which they are not used to. Many EHR systems focus on the physician exam by creating an electronic interface for the physician to document aspects of the patient encounter. However, existing systems do not adequately capture the efficiency of using an EHR during a physician exam. Some embodiments of the invention provide an objective reporting framework to measure the time physicians and other healthcare personnel spend on each patient encounter.

Applicants have recognized and appreciated that the physician exam is not the only portion of a patient visit during which workflow efficiencies may be tracked. From the time a patient enters a medical practice until the patient is finished with the visit, multiple employees of the medical practice (e.g., physicians, medical staff, receptionists etc.) have responsibilities for ensuring that the patient's visit proceeds in an efficient manner. To this end, some embodiments of the invention are directed to defining and tracking time spent entering information in multiple stages of a patient visit to identify key workflows and best practices for healthcare providers of a medical practice.

Some embodiments of the present invention are directed to a method of facilitating collection of information during a patient visit to a healthcare provider. The method comprises associating each of a plurality of tasks with a plurality of stages of the patient visit; and guiding at least one user through one or more of the plurality of stages of the patient visit to complete the plurality of tasks during the patient visit, wherein guiding the at least one user comprises: displaying on a user interface, at least one page for collecting the information during the patient visit; and receiving input entered by the at least one user, wherein the input corresponds to the information.

Some embodiments are directed to at least one computer-readable medium encoded with a plurality of instructions that, when executed by a computer, perform a method. The method comprises associating each of a plurality of tasks with a plurality of stages of a patient visit; and guiding at least one user through one or more of the plurality of stages of the patient visit to complete the plurality of tasks, wherein guiding the at least one user comprises: displaying on a user interface, at least one page for collecting information during the patient visit; and receiving input entered by the at least one user, wherein the input corresponds to the information.

Some embodiments are directed to a computer system configured to enable at least one user to enter information for a patient during a patient visit to a healthcare provider. The computer system comprises at least one processor programmed to: associate each of a plurality of tasks with a plurality of stages of the patient visit; and guide the at least one user through one or more of the plurality of stages of the patient visit to complete the plurality of tasks, wherein guiding the at least one user comprises: displaying on a user interface, at least one page for collecting the information during the patient visit; and receiving input entered by the at least one user, wherein the input corresponds to the information.

Some embodiments are directed to a method of evaluating an efficiency of a patient visit workflow for at least one medical practice, the method comprising: determining an amount of time spent documenting information during each of a plurality of stages of a patient visit; and determining at least one performance metric for the at least one medical practice based, at least in part on the determined amount of time spent documenting information.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic of network environment at a medical practice in which some embodiments of the invention may be employed;

FIG. 2 is a flow chart of a patient visit workflow in accordance with some embodiments of the invention;

FIG. 3 is an appointment page for a user interface that is associated with a check-in stage of a patient visit in accordance with some embodiments of the invention;

FIGS. 4A and 4B are portions of a check-in page for a user interface that is associated with a check-in stage of a patient visit in accordance with some embodiments of the invention;

FIG. 5 is a clinical inbox page for a user interface in accordance with some embodiments of the invention;

FIGS. 6A-6D are portions of an intake page for a user interface that is associated with an intake stage of a patient visit in accordance with some embodiments of the invention;

FIGS. 7A and 7B are portions of an exam page for a user interface that is associated with an exam stage of a patient visit in accordance with some embodiments of the invention;

FIGS. 8A-8D are portions of a sign-off page for a user interface that is associated with a sign-off stage of a patient visit in accordance with some embodiments of the invention;

FIGS. 9A-9C are portions of a checkout page for a user interface that is associated with a checkout stage of a patient visit in accordance with some embodiments of the invention;

FIGS. 10A and 10B are portions of a charge entry page for a user interface that is associated with a checkout stage of a patient visit in accordance with some embodiments of the invention;

FIG. 11 is a claim review page for a user interface the is associated with a checkout stage of a patient visit in accordance with some embodiments of the invention;

FIG. 12 is a schematic of a practice management system in accordance with some embodiments of the invention;

FIG. 13 is a schematic displaying a plurality of analysis that may be performed by the practice management system shown in FIG. 12;

FIG. 14 is a summary report for same day encounter close rate that may be generated by a practice management system in accordance some embodiments of the invention;

FIG. 15 is a provider report for same day encounter close rate that may be generated by a practice management system in accordance some embodiments of the invention;

FIG. 16 is a summary report for documentation time that may be generated by a practice management system in accordance some embodiments of the invention;

FIG. 17 is a summary report for documentation time for a plurality of stages of a patient visit that may be generated by a practice management system in accordance some embodiments of the invention;

FIG. 18 is a provider report for documentation time that may be generated by a practice management system in accordance some embodiments of the invention;

FIG. 19 is a summary report for documentation time during patient visits that may be generated by a practice management system in accordance some embodiments of the invention;

FIG. 20 is a provider report for documentation time during patient visits that may be generated by a practice management system in accordance some embodiments of the invention;

FIG. 21 is a summary report for delegation percentage that may be generated by a practice management system in accordance some embodiments of the invention;

FIG. 22 is a provider report for delegation percentage that may be generated by a practice management system in accordance some embodiments of the invention; and

FIG. 23 is a schematic of a network environment in which some embodiments of the invention may be employed.

### DETAILED DESCRIPTION

The present disclosure generally relates to inventive methods and apparatus for facilitating a patient visit workflow using an EHR system. When a patient visits a healthcare provider at a medical practice, multiple people at the medical practice are responsible for performing tasks related to the patient's visit. For example, when a patient arrives at the medical practice, front desk staff may be responsible for collecting information from the patient including, but not limited to, the reason for the patient visit, insurance information, and patient registration information. Once this information has been collected, a medical assistant (e.g., a nurse) may review the collected information and ask the patient follow-up questions, if necessary, to provide additional details such as the patient's current health status and/or health changes since the patient's last visit to the healthcare provider. The medical assistant may also perform some diagnostic tests on the patient to determine, among other things, the patient's vital signs, and to determine recommendations for the healthcare provider who will examine the patient. A healthcare provider may then examine the patient, perform one or more tests, and/or order one or more laboratory procedures for the patient. After the patient has been examined by the healthcare provider, the patient may schedule one or more follow-up visits with the front desk staff prior to leaving the medical practice office.

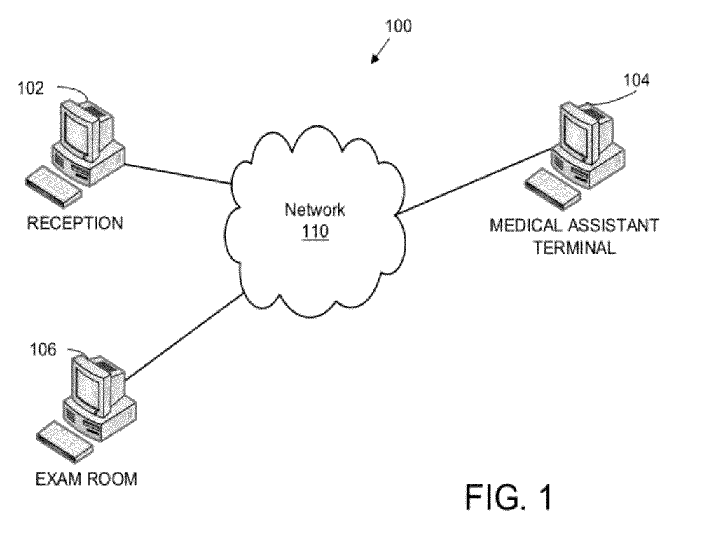

Applicants have recognized and appreciated that the efficiency of a patient visit may be improved by allowing each of the healthcare employees involved in a patient visit to a healthcare provider to interact with an electronic health information system that guides the employees through the patient visit. An exemplary health information system 100 in accordance with some embodiments of the invention is schematically shown in FIG. 1. Health information system 100 may include a plurality of user terminals, wherein each of the user terminals is connected to a network 110 that enables healthcare employees to enter information into a centralized electronic health record (EHR) system. For example, the healthcare information system 100 may include a reception computer 102 that front desk staff may use to enter information when a patient arrives at the healthcare provider's office and/or prior to the patient leaving the healthcare provider's office. Such information may include, but is not limited to, scheduling information, insurance information, and other information specific to the patient visit.

Health information system 100 may also include exam room computer 104 that a physician or other healthcare provider may use during a patient exam to enter healthcare information related to the patient visit and a medical assistant terminal 106 that a nurse or other healthcare staff may use to enter health information during the patient visit. It should be appreciated that health information system 100 may include any number and/or type of computers and embodiments of the invention are not limited in this respect. For example, although all of the computers shown in FIG. 1 illustrated as desktop computers, in some embodiments, one or more healthcare providers or staff may use a portable computer such as a tablet computer, personal digital assistant (PDA), smartphone, or other mobile computing device to enter health information during a patient visit. Additionally, multiple healthcare employees may use the same computer to enter health information and/or a single healthcare employee may use multiple computers to enter health information.

Any suitable type of network 110 may be used to enable computers in health information system 100 to communicate. For example, network 110 may be a local area network (LAN) and/or a public network, such as the Internet. In some embodiments, health information may be entered into one or more health information data stores hosted by a practice management system, as described in more detail below. In such embodiments, users at the healthcare provider may access one or more portions of a user interface that enable users to enter the health information via, for example, a web browser displayed on the user's computer. In some embodiments, the health information system may comprise an electronic health records (EHR) system that is hosted by a practice management system. Further details regarding an exemplary practice management system in accordance with some embodiments of the invention are discussed in more detail below.

In some embodiments, a patient visit is divided into a plurality of stages that are associated with particular tasks to be performed during a patient visit. By aligning particular user tasks with the one or more stages, each employee's role and responsibilities during the patient visit may be more clearly defined, thereby improving the patient visit workflow. Additionally, patient progress through a patient visit may be compared with an amount of time that users spend documenting tasks during the patient visit.

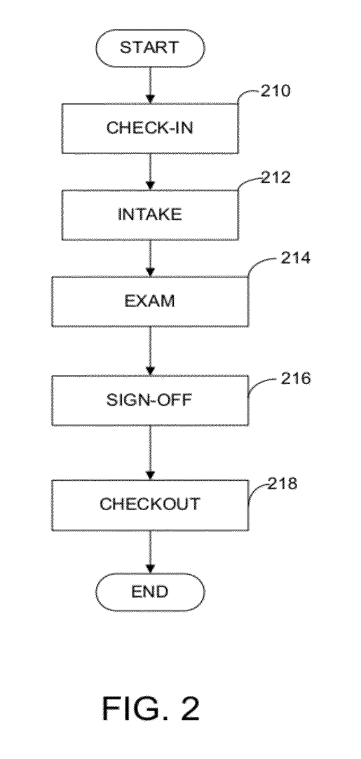

An exemplary five-stage patient visit workflow is illustrated in FIG. 2. During check-in stage 210, front desk staff may be responsible for entering scheduling, insurance, and/or demographic information when the patient arrives at the medical practice. After the patient has been checked in, a medical assistant may be notified that the patient is waiting in the waiting room and has completed check-in stage 210. The patient visit proceeds to the intake stage 212, wherein the medical assistant may be responsible for reviewing the information entered by the front desk staff during check-in stage 210. During intake stage 212, the medical assistant may also enter other data into the EHR system including, but not limited to, vital signs and medical history information. Once the medical assistant has completed intake stage 212, a healthcare provider (e.g., a physician) may be notified that the patient is finished with intake and is ready to be examined. The patient visit proceeds to exam stage 214 during which the healthcare provider may examine the patient and enter health information related to the patient exam into the EHR system. The health information may be entered in any suitable manner, and embodiments of the invention are not limited in this respect. For example, during the exam, the healthcare provider may dictate notes to be entered into the system by the provider's assistant or other staff at a later time. Alternatively, the healthcare provider may interact directly with a user interface of the EHR system to enter the patient's health information during exam stage 214. Once the healthcare provider has completed the examination of the patient, the patient visit proceeds to the sign-off stage 216 during which the healthcare provider or an authorized healthcare employee is responsible for signing-off on orders and/or billing for procedures performed or services rendered during the patient visit. After the sign-off stage 216 has been completed, the patient visit proceeds to the checkout stage 218 during which the receptionist or front desk staff is responsible for, among other things, scheduling follow-up appointment(s), remitting payment for the visit, and/or creating claims for procedures performed or services render during the patient visit. Once the front desk staff has completed the checkout stage 218, the patient visit ends. Each of the patient visit stages illustrated in FIG. 2 are described in more detail below. Although FIG. 2 describes a patient visit that has been divided into five stages, it should be appreciated that any suitable number of stages may alternatively be used, and embodiments of the invention are not limited in this respect.

As described above, in some embodiments, a use may interact with an EHR system via a user interface that enables users to enter and/or access health information for a patient during a plurality of stages of a patient visit. Exemplary portions of a user interface in accordance with some embodiments of the invention are now described. In some embodiments, the EHR system includes an appointment scheduling system. The appointment scheduling system may enable staff at a medical practice to schedule patient appointments and to view patient appointments for a particular day, week, or month. The user interface may be configured to display, upon accessing the EHR system, the patient appointments for the current day. The patient appointments may be displayed in any suitable manner and embodiments of the invention are not limited in this respect. For example, the appointments may be displayed as a portion of calendar indicating the times and/or days on which patients are scheduled to visit the healthcare provider's office.

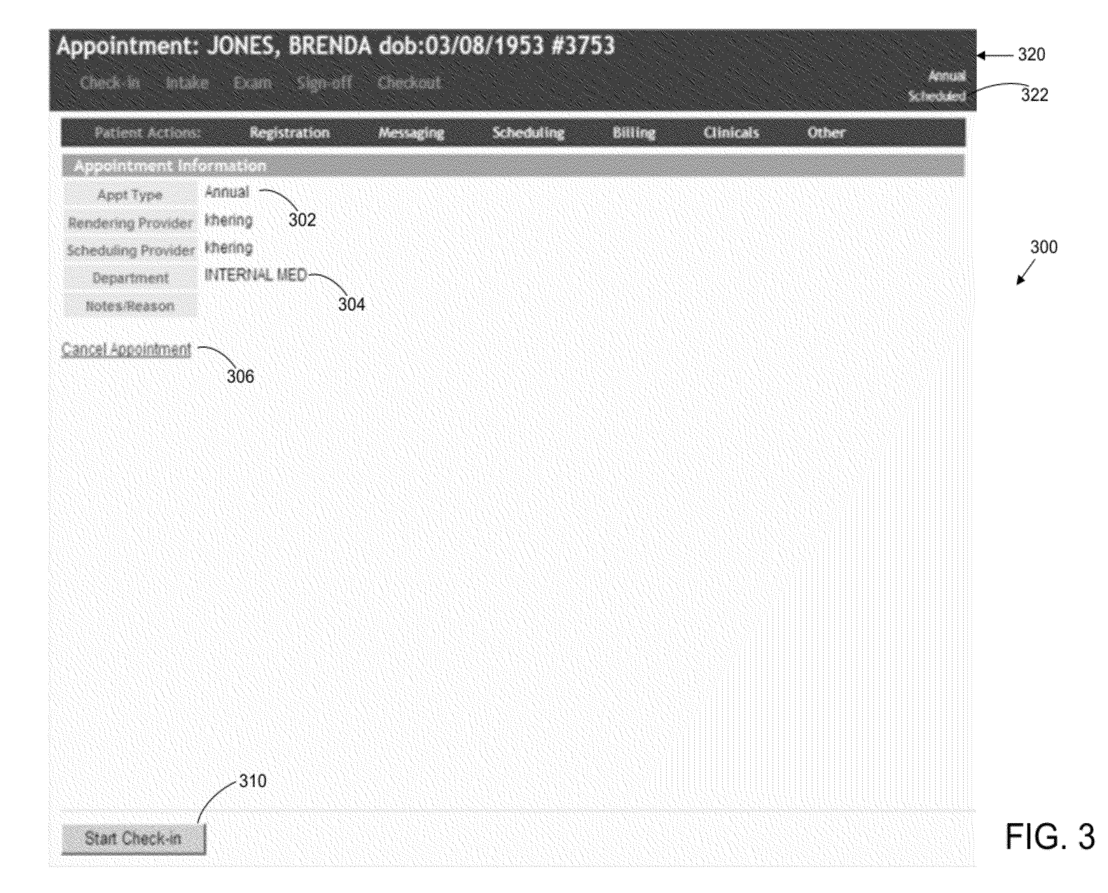

When a patient arrives at a medical practice, the front desk staff may interact with an appointment scheduling component of the EHR system to select the patient that has arrived for their appointment. In response to selecting the patient, an appointment page 300 may be displayed on the user interface as shown in FIG. 3. The appointment page 300 may include patient visit header 320 that displays demographic information about the patient including, but not limited to, the patient's name, age, date of birth, and identification number. Patient visit header 320 may also include an indicator of the multiple stages that are to be completed during the patient's visit to the medical practice. As the patient progresses through the different stages of the patient visit, the stage indicator(s) displayed in the patient visit header may be modified to reflect which stages have been completed and/or the current stage of the patient. By clearly indicating which stages have been completed, it can be ensured that all tasks associated with each stage of the patient visit are completed prior to the patient leaving the medical practice. The current stage may be indicated in any suitable way. For example, the current stage may be highlighted, underlined, and/or the font color may be changed. The current status 322 of the patient may also be indicated in the patient visit header 320. For example, prior to check-in, the status of the patient may be indicated as “Scheduled.”

Appointment page 300 may additionally include information about the selected patient's appointment including the appointment type 302, the department 304 with which the appointment was made, and/or any other information about the patient's appointment. Appointment page 300 may also include a cancellation selector that, when selected by a user, removes the patient's appointment from the appointment scheduling component of the EHR system. Once the user (e.g., the front desk staff) has verified the information on the appointment page 300, the user may interact with the start check-in selector 310 to begin the check-in stage of the patient visit.

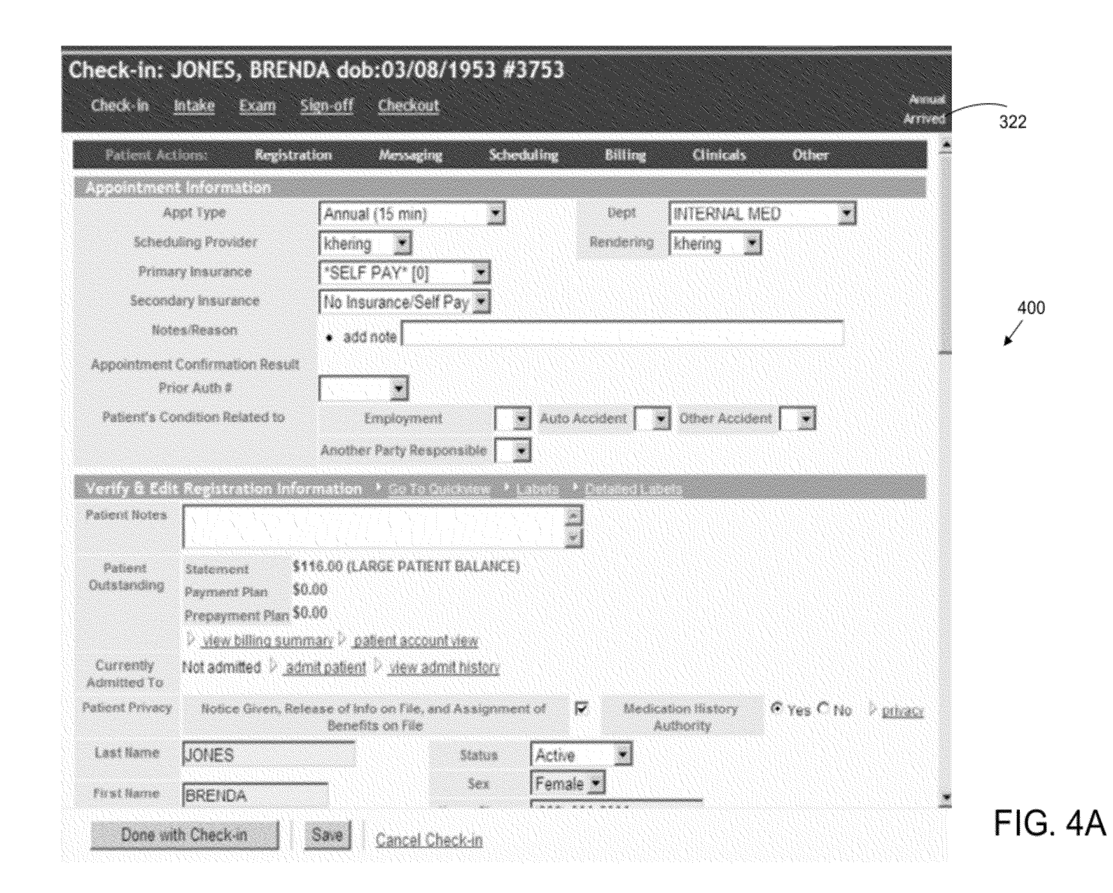

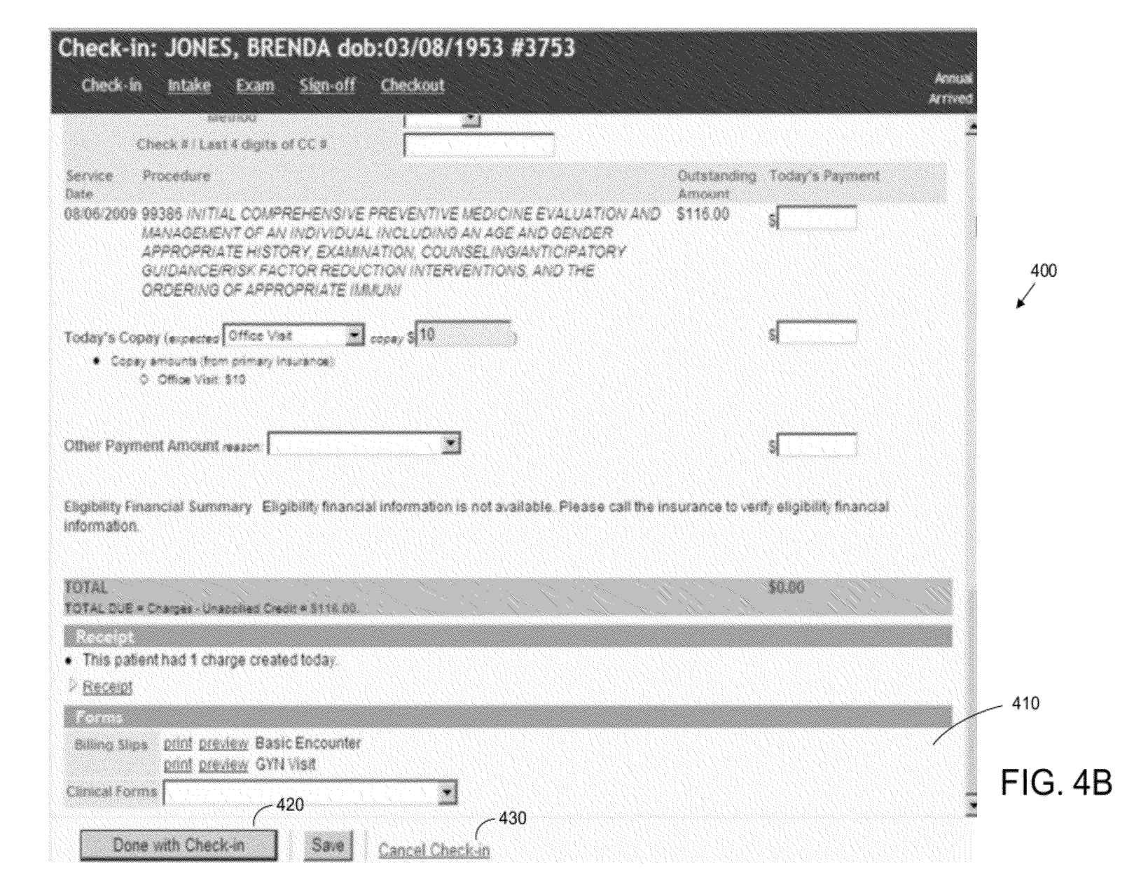

After selecting start check-in selector 310, the user interface may be configured to display check-in page 400 as shown in FIGS. 4A and 4B. Upon displaying check-in page 400, current status 322 in the patient header 320 may be updated to reflect that the check-in stage has started. For example, current status 322 may be changed to “Arrived” to indicate that the patient is at the healthcare provider's office. Check-in page 400 may include a plurality of fields that enable the user (e.g., front desk staff) to perform check-in tasks including, but not limited to, confirming check-in information including appointment and demographic information, validating the patient's insurance information, adding pharmacy information, and collecting any payments.

If appropriate, the user also may interact with check-in page 400 to change the rendering healthcare provider (e.g., the physician, physician's assistant, or nurse practitioner scheduled to see the patient), the appointment type, and/or privacy settings associated with the patient's health information. By enabling the user to configure these aspects (and others) during the check-in stage of the patient visit, the EHR system may be properly configured to guide other users through the remainder of the patient visit. For example, changing the rendering provider may change one or more forms in the EHR system that may be specific to that rendering provider and may require the signature of the selected rendering provider. Additionally, different types of appointments may be associated with different encounter layouts within the EHR system, and ensuring that the correct appointment type is selected at check-in will facilitate the entry of health information throughout the rest of the patient visit. In some embodiments, check-in page 400 may also include forms section 410 as shown in FIG. 4B. A user may interact with forms section 410 to print or preview one or more billing slips or clinical forms, such as a registration/health history form, a progress note, and/or a procedure consent form.

After the user has verified and/or entered the information in check-in page 400 for the patient, the user may interact with done with check-in selector 420 to indicate that the patient is checked-in. Alternatively, if at any time, the user wishes to cancel the check-in process, the user may interact with cancel check-in selector 430 which, when selected may cancel the check-in process for the selected patient. After the user has completed the check-in stage for the patient, the status of the patient displayed in the patient visit header may be changed to reflect that the patient has completed the check-in stage. For example, the patient status may be changed to “Ready for Staff” when the done with check-in selector 420 is selected by the user. After completing check-in for the patient, the front desk staff member may proceed to check in another patient using a similar procedure as just described. In this way, the front desk staff of a medical practice are guided through and may focus on the particular tasks assigned to them in the EHR system, without having to be concerned with the other parts of the patient visit.

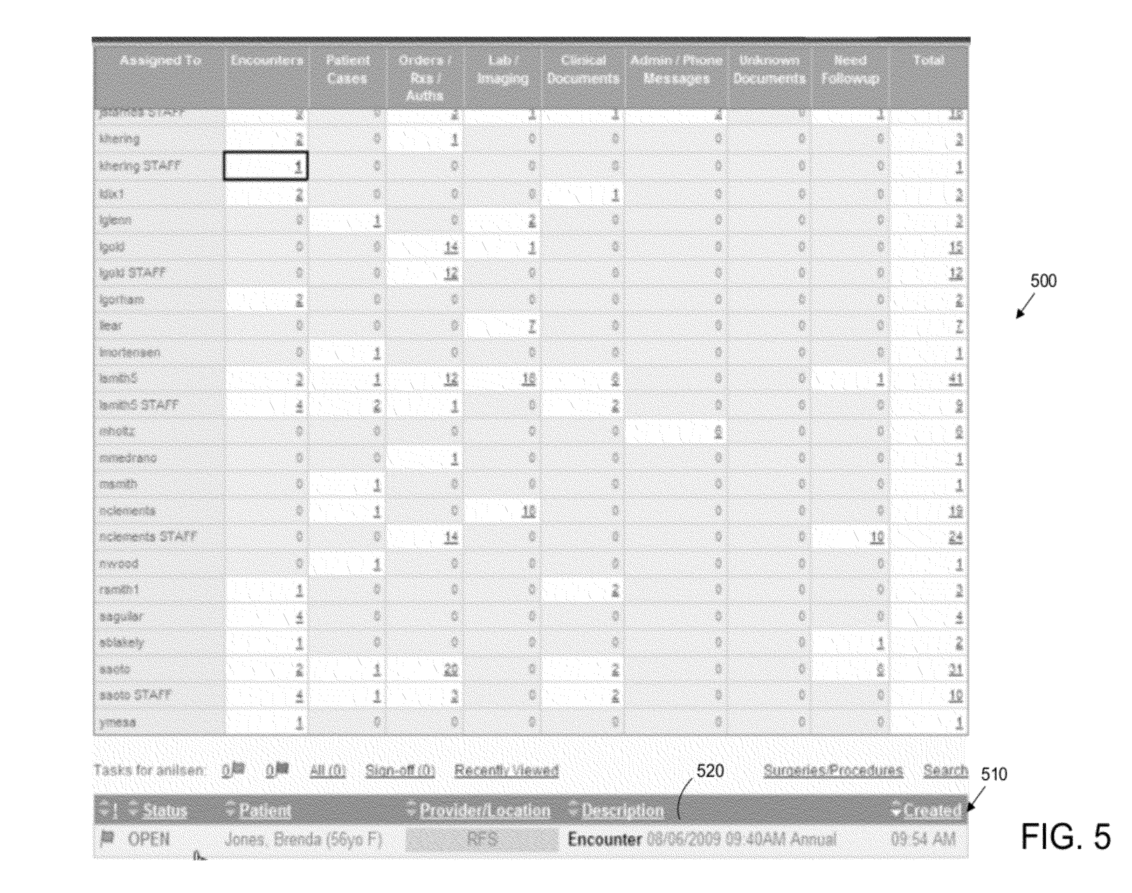

In some embodiments, the user interface associated with the EHR system may be configured to display a clinical inbox page 500 as shown in FIG. 5. Clinical inbox page 500 may include an indication of one or more tasks for healthcare provider staff members at a medical practice. For example, as shown in FIG. 5, each of the staff members may have an associated clinical inbox that displays their assigned tasks. Continuing with the example above, after a patient has been checked in, a clinical staff member may interact with clinical inbox page 500, on which it is indicated in box 510 that the patient has been checked in and is ready to be brought back to an exam room. The clinical staff member assigned to the patient (e.g., the staff of the rendering provider) may interact with patient encounter selector 520 to begin the intake stage for the patient.

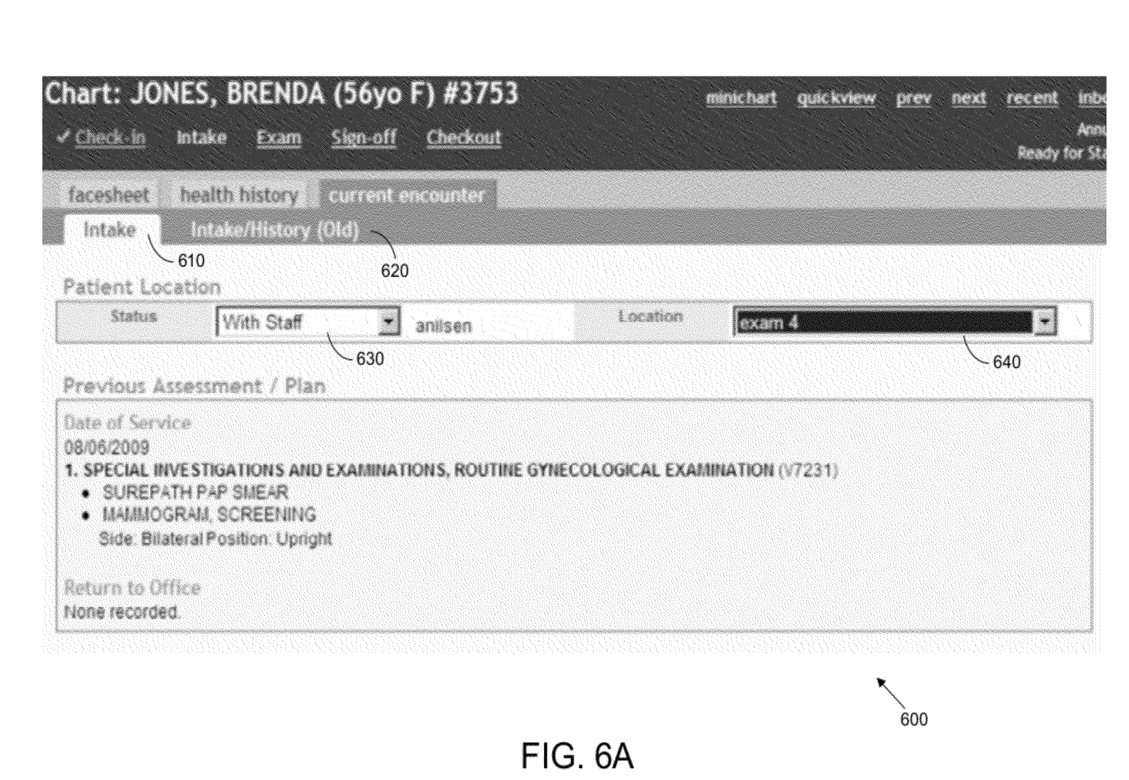

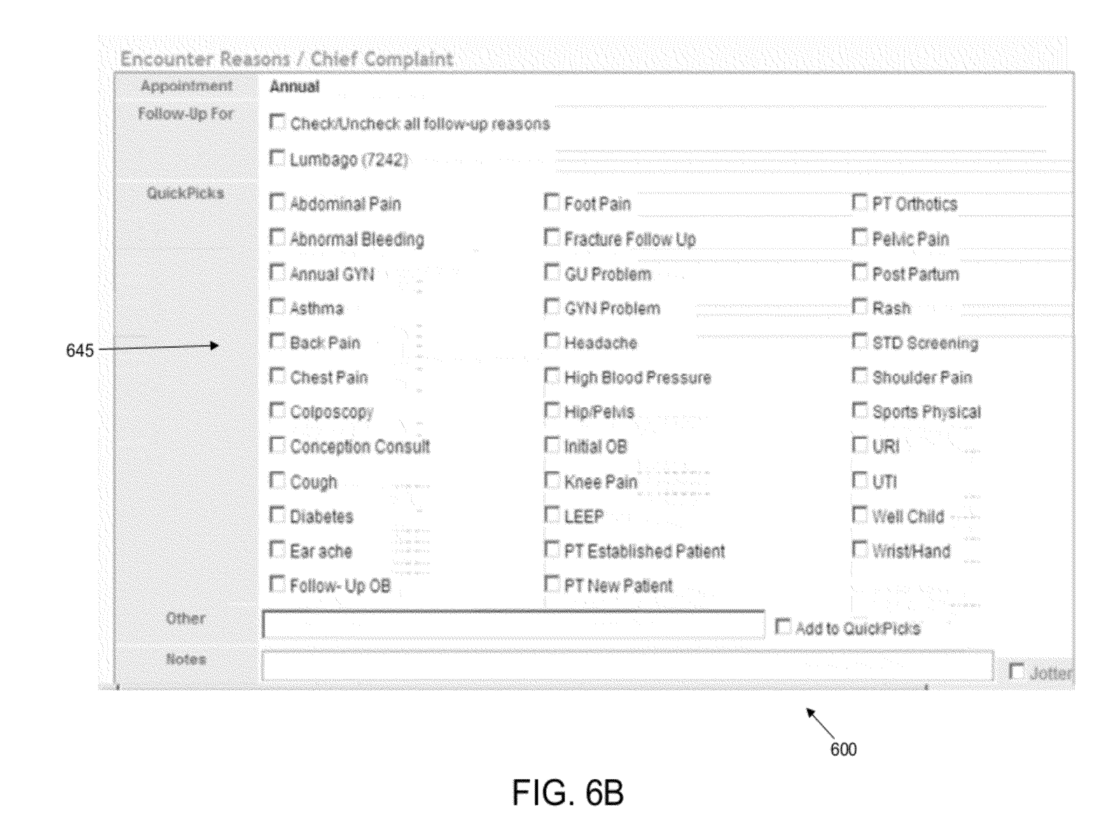

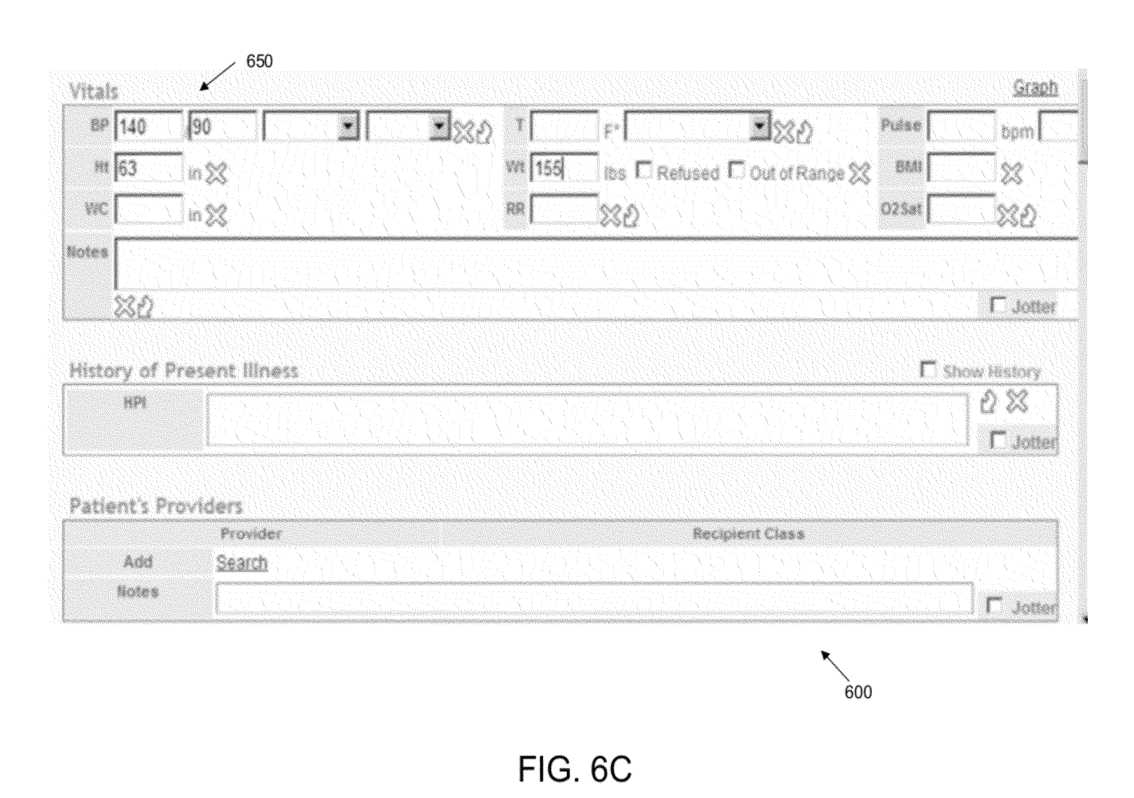

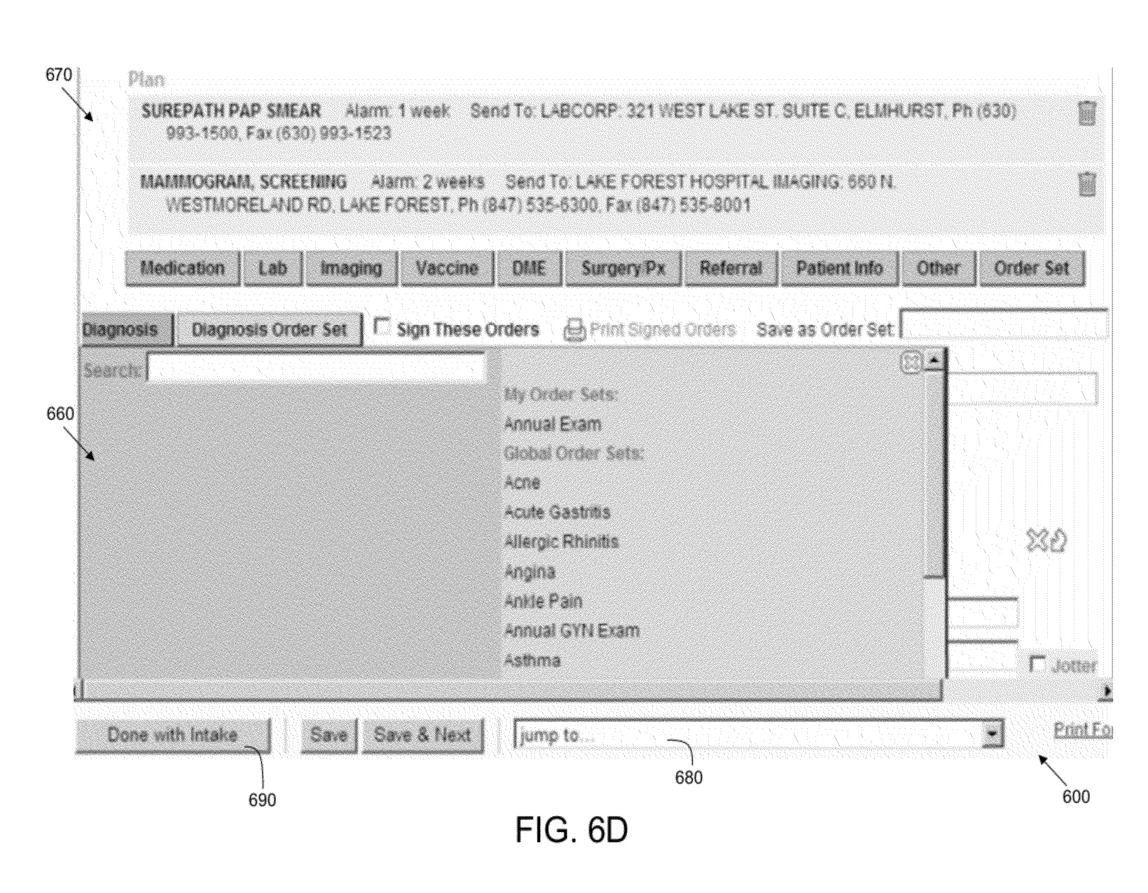

After a user has selected the patient encounter selector 520, the user interface may be configured to display intake page 600 illustrated in FIGS. 6A-6D. Intake page 600 may include one or more intake tabs that may be selected by a user to enable the user to enter information into the EHR system. In some embodiments, intake page 600 may include multiple intake tabs including intake tab 610 which, when selected, displays a “Recommended Best Practices” configuration for patient intake and intake tab 620 which, when selected, displays a practice-specific configuration for patient intake. However, it should be appreciated that in some embodiments, only a single intake tab (or no intake tab) may be displayed and aspects of the invention are not so limited.

After the patient has been brought back to an exam room, a user (e.g., a medical assistant for the rendering provider) may interact with intake page 600 to change the status of the patient to reflect the current status and location of the patient. For example, a user may interact with the status selector 630 to change the current status of the patient to “With Staff.” Additionally, a user may interact with location selector 640 to select the exam room where the patient is located. In the example, shown in FIG. 6A, this corresponds to exam room 4. In some embodiments, a patient status indicator in patient visit header 322 and/or an entry in clinical inbox 500 may be updated in response to a user interacting with location selector 640, thereby communication to other users in the medical practice that the patient is being seen and that a particular exam room is being used. Informing users of the medical practice about a current status of a patient may improve the medical practice's efficiency in handling patient visits.

During the intake stage a medical assistant may ask the patient a series of questions regarding the reason(s) for the visit to the healthcare provider. The medical assistant may add the patient's responses to the EHR system by interacting with encounter reasons section 645 of intake page 600 as shown in FIG. 6B. For example, if the patient's reason for visiting the healthcare provider is to have her annual gynecological exam, the medical assistant may interact with encounter reasons section 645 to select the corresponding indicator. In some embodiments, a patient status indicator in patient visit header 322 and/or an entry in clinical inbox 500 may be updated in response to a user interacting with encounter reasons section 645, thereby enabling other users in the medical practice to better prepare for subsequent tasks to be performed during the patient visit.

The medical assistant may also perform one or more measurements for vital signs and may record this health information in vital signs section 650 of intake page 600 as illustrated in FIG. 6C. For example, during the intake stage the medical assistant may measure the patient's blood pressure and height and may enter the corresponding values into vital signs section 650. Any other suitable health information may also be collected and entered by the medical assistant during the intake stage, and embodiments of the invention are not limited in this respect.

As shown in FIG. 6D, intake page 600 may include diagnosis order section 660. The medical assistant may interact with diagnosis order section 660 to select one or more orders associated with the patient visit. For example, if the patient has visited the healthcare provider for an annual exam, the medical assistant may select “Annual Exam” from a list of order sets displayed in diagnosis order section 660. In response to selecting the order set, the one or more orders associated with the order set may be displayed in order section 670 as shown in FIG. 6D. Queuing the orders for the healthcare provider to sign off on later in the patient visit allows the healthcare provider to reduce the amount of time needed to determined and/or select the appropriate orders for the patient during the patient visit.

In some embodiments, intake page 600 may include jump selector 680. By interacting with jump selector 680, the user may select a particular section of intake page 600 with which to interact. For example, a medical assistant may interact with jump selector 680 to select “Intake: Vitals.” By selecting “Intake: Vitals,” the user interface may be updated to display vital signs section 650 to enable the medical assistant to enter and/or correct vital signs health information in the EHR system. After the medical assistant has completed the intake stage by entering all of the appropriate information into the EHR system, the medical assistant may interact with the done with intake selector 690 to indicate that the patient has completed the intake stage of the visit. In response to interacting with done with intake selector 690, the rendering healthcare provider for the patient may be notified that the patient has completed the intake stage and is ready to be examined. For example, the clinical inbox of the provider (e.g., a physician) may be updated to reflect that the patient has completed the intake stage and is ready for exam in exam room 4. However, it should be appreciated that the provider may be notified in any other suitable way and embodiments of the invention are not limited in this respect. In addition, the current status of the patient may be changed to “Ready for provider” to indicate that the patient has finished the intake stage of the visit.

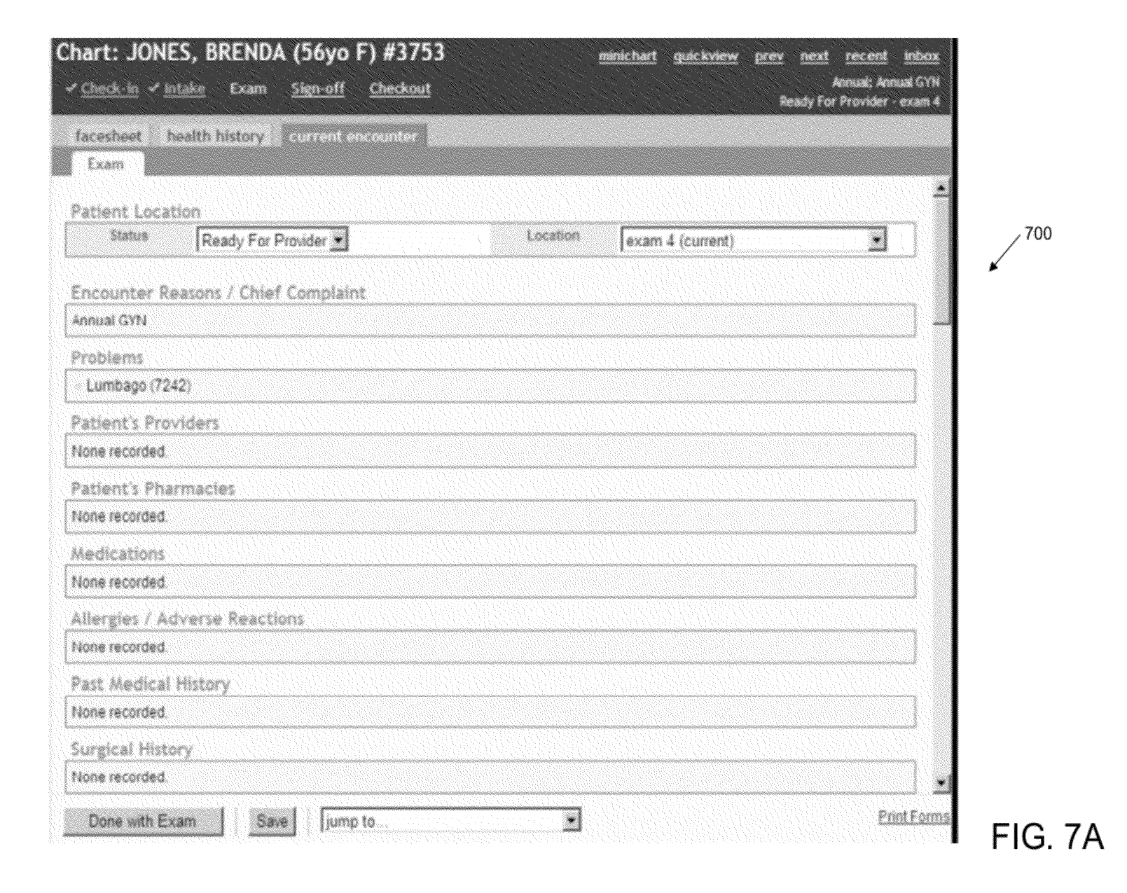

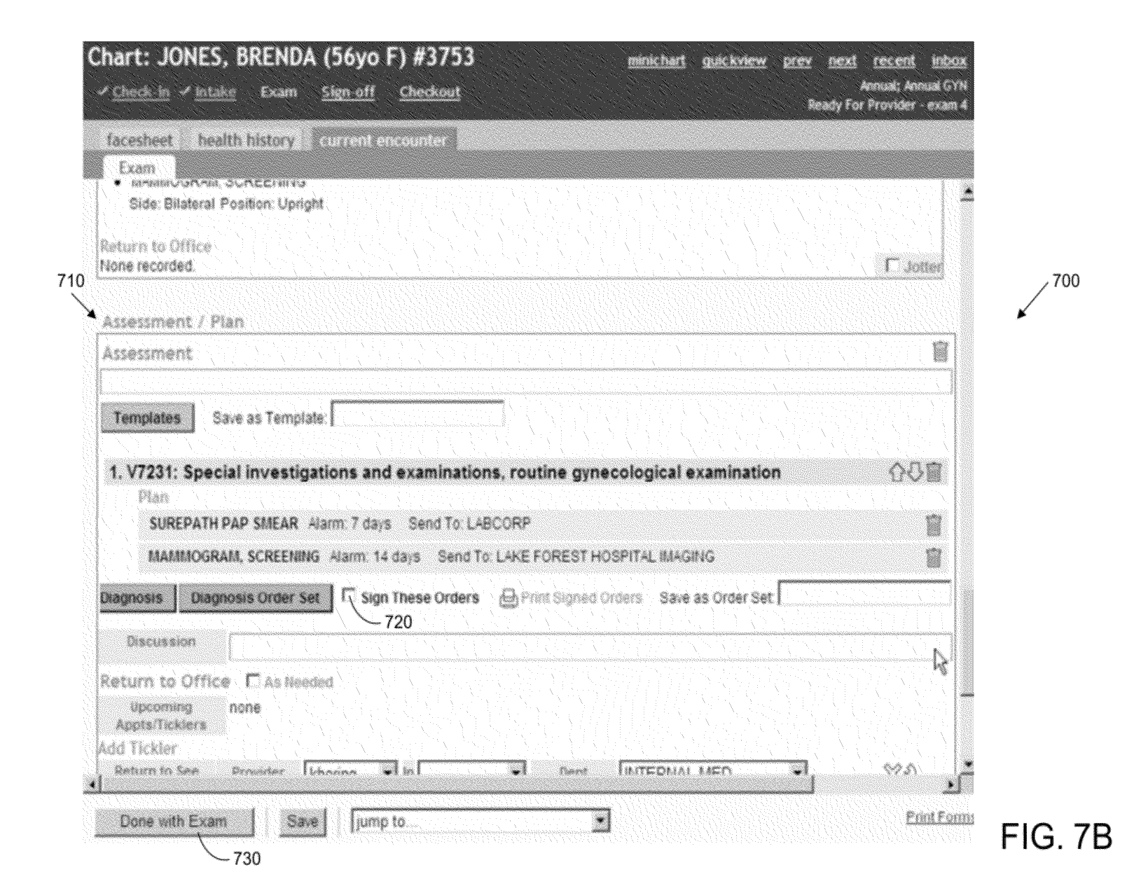

After determining that the intake stage has completed and a patient is ready for exam (e.g., by viewing the patient's status in the provider's clinical inbox), the healthcare provider may interact with the user interface to select a patient indicator displayed on the user interface in order to begin the exam stage. Upon selecting the patient, the user interface may display exam page 700 as shown in FIGS. 7A and 7B. Exam page 700 may include a plurality of fields that enable the provider to review information previously entered by the medical assistant during intake including, but not limited to the patient's reason(s) for the visit to the healthcare provider. The provider may interact with one or more of the plurality of fields to update the information in the EHR system, if necessary.

The provider may then proceed to interact with the user interface to document various aspects of the encounter with the patient. In some embodiments, the provider may interact directly with the user interface to enter health information about the patient during the encounter. However, in other embodiments, the provider may document various aspects of the encounter using other methods including, but not limited to, dictating the health information, making written notes including the health information, and typing the health information into a separate document. The health information recorded by the provider may then be later entered into the corresponding fields in exam page 700 by the provider or another user authorized to enter the information into the EHR system on the provider's behalf.

In some embodiments, exam page 700 may include fields for a subjective examination by the physician including History of Present Illness (HPI) and Review of Systems (ROS) fields. Additionally, exam page 700 may include fields for an objective examination by the physician including Physical Exam (PE) and Document Review fields. It should be appreciated, however, that any other suitable types of fields may also be included in exam page 700 and embodiments of the invention are not limited in this respect.

In some embodiments, exam page 700 includes assessment and plan section 710 as shown in FIG. 7B. Assessment and plan section 710 may include a results and interpretation section and an indication of the orders that were previously selected during the intake stage. If the provider agrees that that these procedures should be ordered, the provider may interact with sign selector 720 to sign the orders indicated in the assessment and plan section 710. After the provider has completed the patient exam, the provider may select the done with exam selector 730 to indicate that the patient is finished with the exam stage.

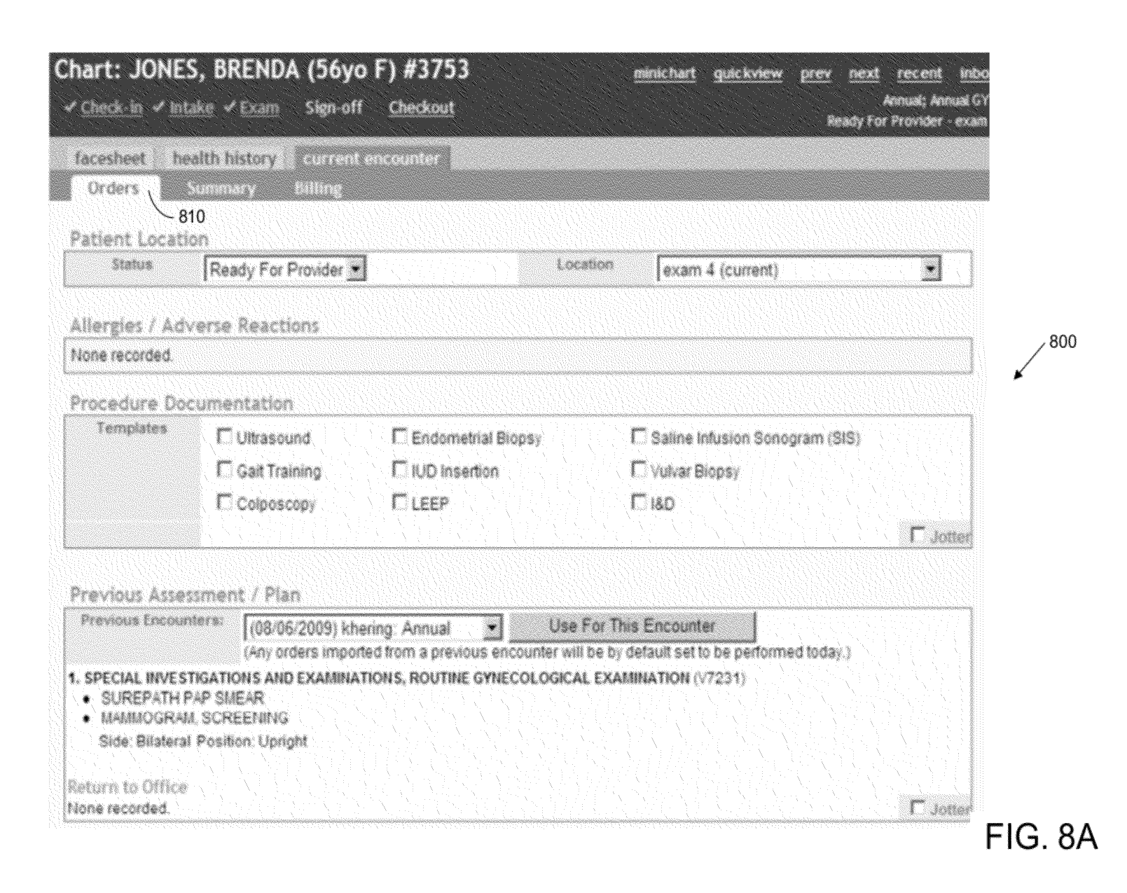

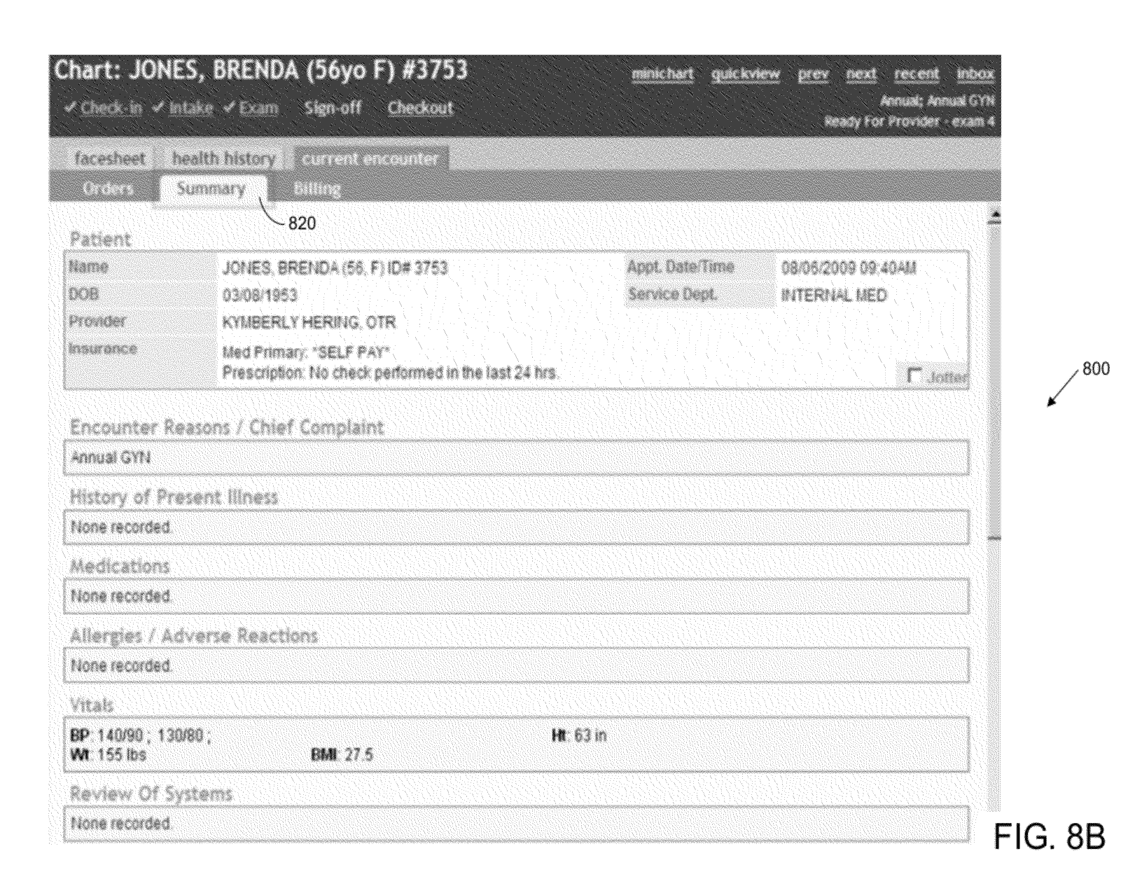

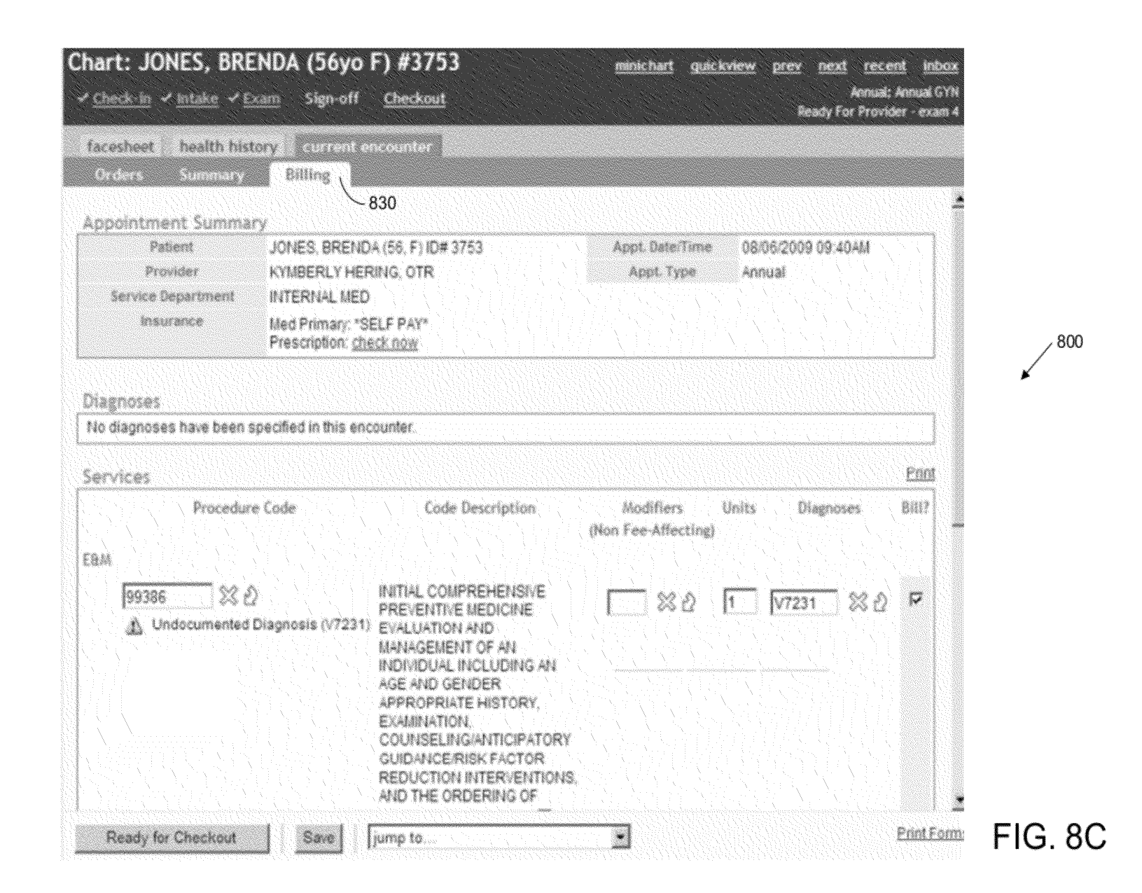

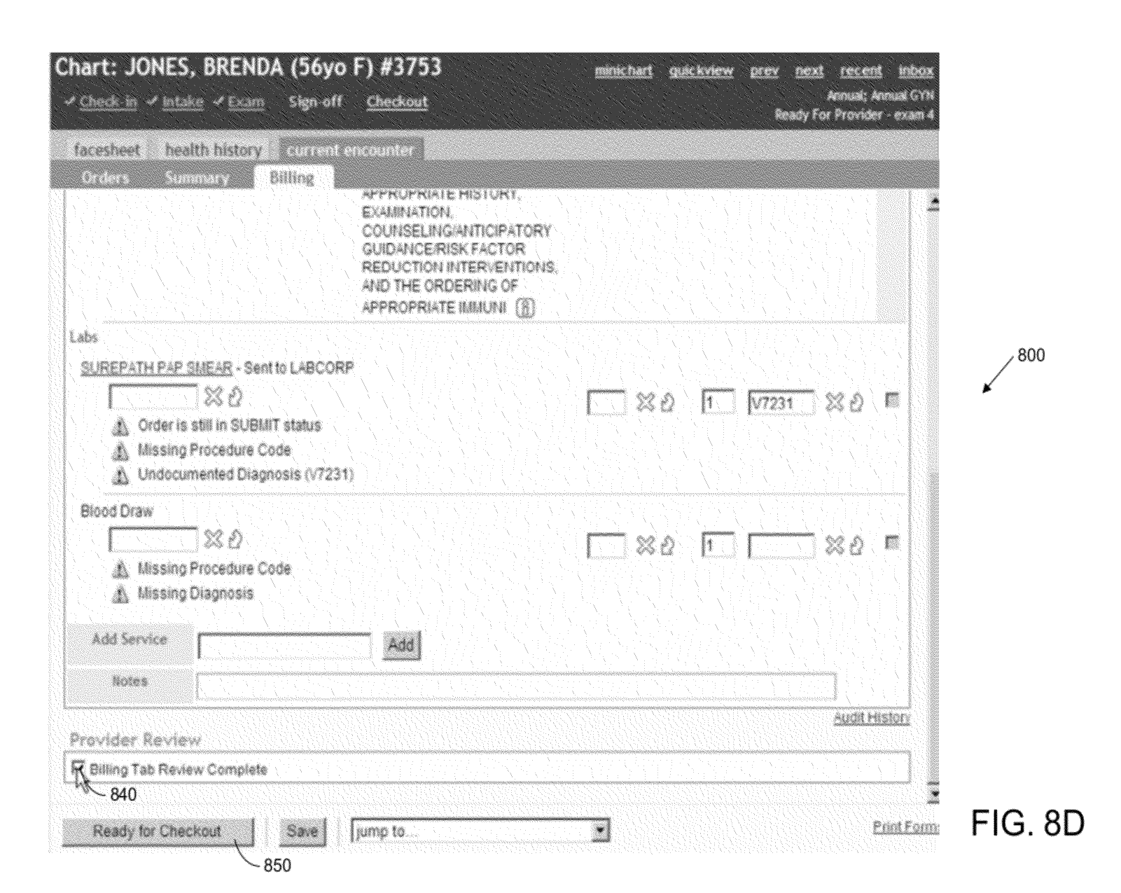

After the exam stage has been completed, the patient visit may proceed to the sign off stage during which the provider may sign off on orders and billing matters associated with the patient visit including, but not limited to, orders and billing matters that enable an effective checkout by the patient and the checkout staff. During the sign off stage, the user interface may be configured to display signoff page 800 as illustrated in FIGS. 8A-8D. Sign off page 800 may include a plurality of tabs that, when selected, enable the provider to sign off on various items related to the patient visit. For example, orders tab 810, when selected, enables the provider to sign off on orders that were indicated during the intake stage and/or the exam stage. If the provider has already signed off on orders during the exam stage, as described above, no further action may need to be taken during the sign off stage. However, if the provider did not sign off of the orders during the exam stage, the indicated orders may be reviewed and signed off on using sign off page 800. Alternatively, if the provider has designated a staff member to indicate and sign off on orders, the staff member may do so using sign off page 800 rather than having to navigate through exam page 700 to sign off on the orders.

Sign off page 800 may also include summary tab 820 that, when selected by a user, displays a plurality of fields representing a summary of the encounter with the patient as illustrated in FIG. 8B. If the provider has entered all of the health information into the EHR system, the provider can review the summary and can sign and close the encounter. However, if the provider has not entered in all of the health information for the encounter, the health information that has been entered may be saved and the encounter can be completed at a later time. If the summary encounter has not been signed by the provider, the user interface may provide a notification to the provider that the encounter is not complete. For example, the clinical inbox for the provider may indicate that there is an open encounter, which has not been signed.

Sign off page 800 may additionally include billing tab 830 that, when selected by a user, displays billing information related to the patient visit as illustrated in FIGS. 8C and 8D. The provider may review the billing information to ensure that there is a placeholder for all services performed during the patient visit. The provider may also interact with one or more of the billing information fields to indicate, for example, billing codes for particular evaluation and management procedures and/or lab procedures performed during the patient visit. After the provider has reviewed the billing information, the provider may interact with the billing tab review complete selector 840 to indicate that the review of the billing information on sign off page 800 is completed.

As with the encounter summary section of sign off page 800, in some embodiments, the provider may not be required to complete a review of the billing information prior to the patient proceeding to the checkout stage. Rather, a review of the billing information may be completed at a later time. If billing information is reviewed at a later time, the provider may be notified that a review of the billing information has not yet been completed. The provider may be notified in any suitable way including, but not limited to, providing an indication in the clinical inbox of the provider that the review of the billing information for the encounter has not been completed. After the provider has finished reviewing and signing off on information indicated in sign off page 800 that is a prerequisite for the patient checking out, the provider may interact with ready for checkout selector 850 to indicate that the patient is ready to proceed to checkout. In response, the current status of the patient may be changed to “Ready for checkout.”

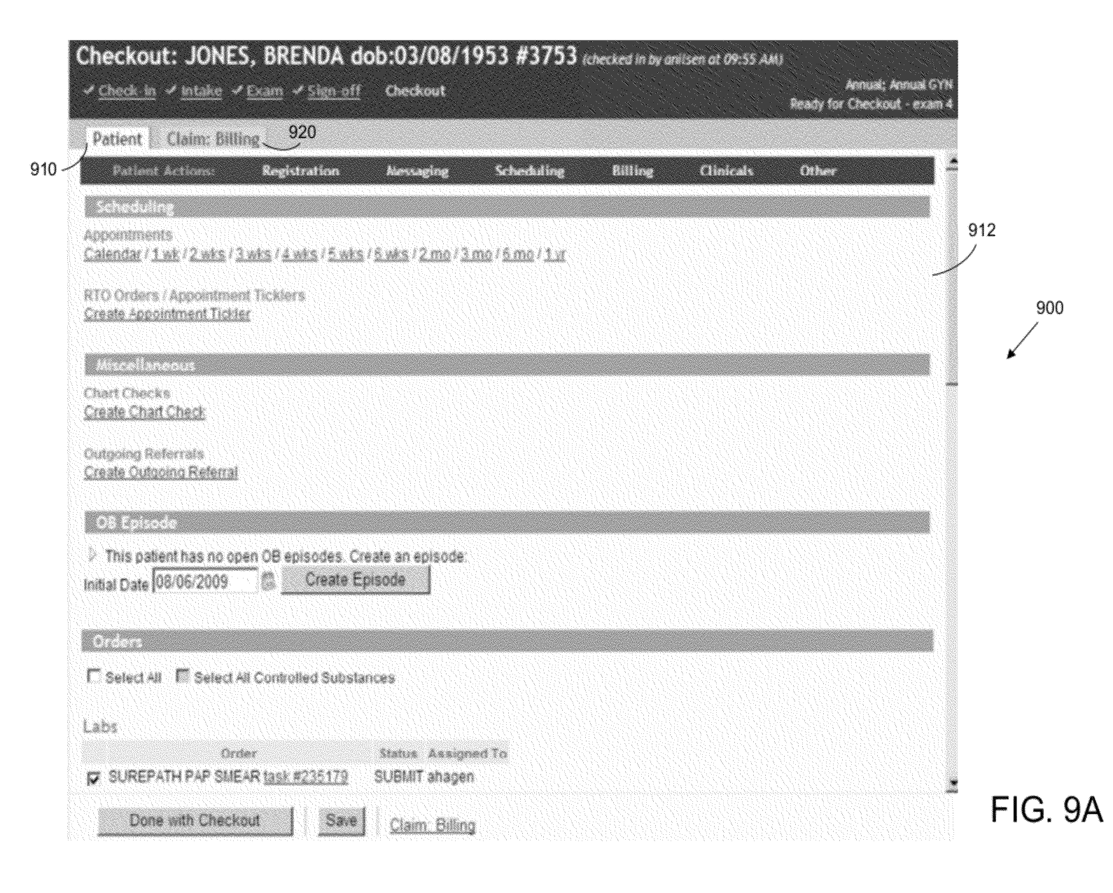

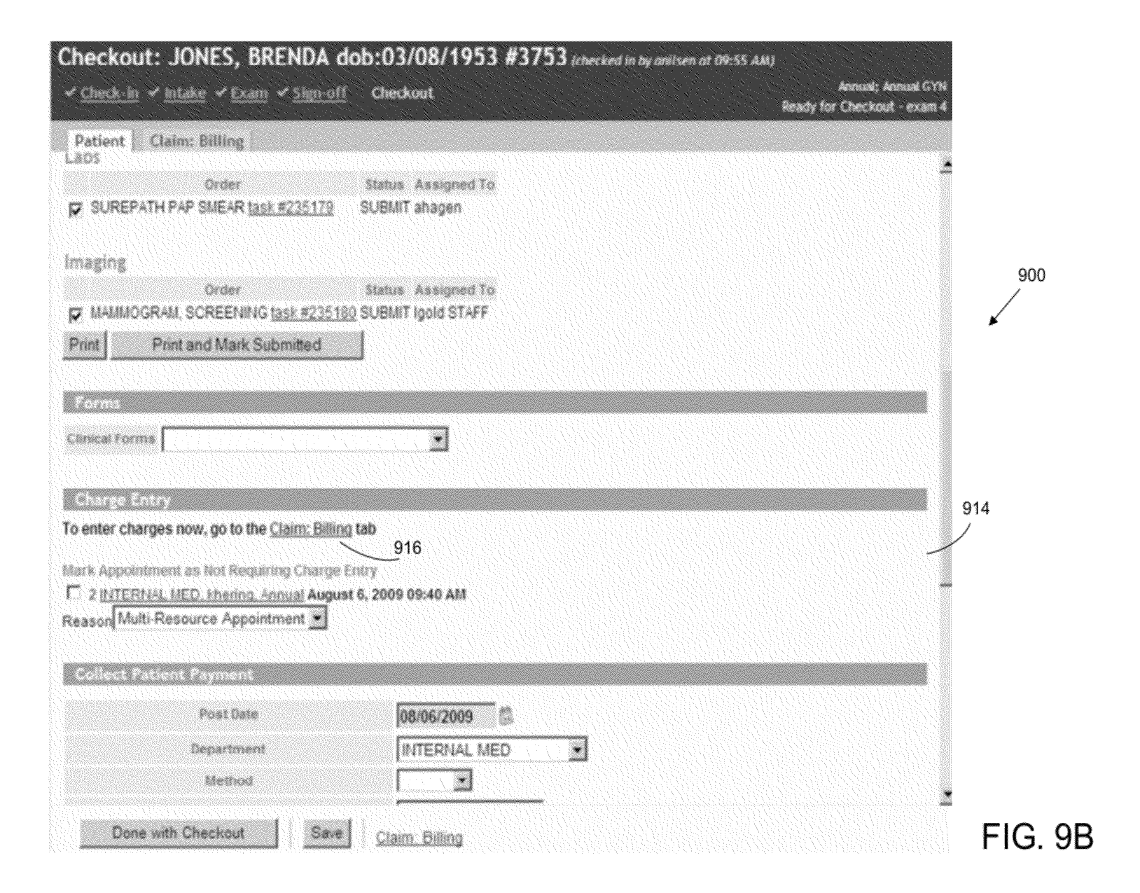

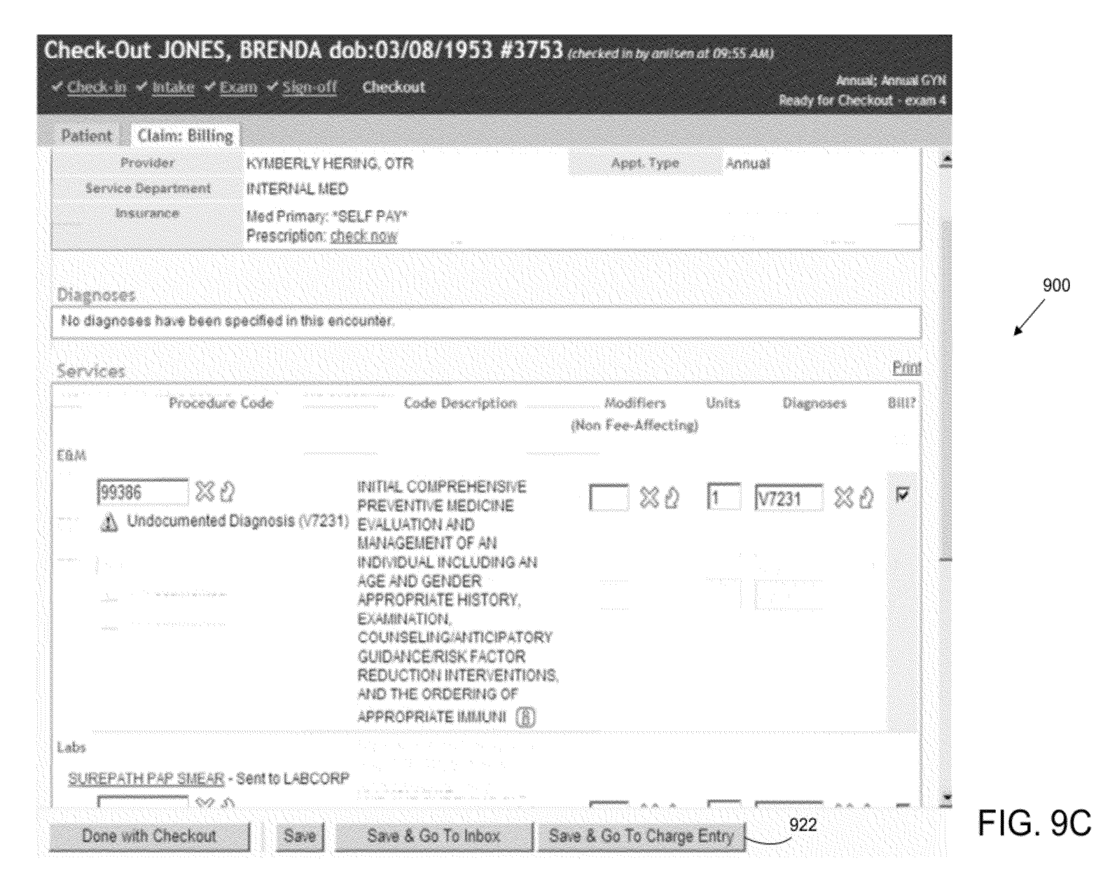

In response to a selection of the ready for checkout selector 850, the front desk staff at the medical practice may be notified that the patient is ready for checkout. The front desk staff may be notified in any suitable way that the patient is ready for checkout and embodiments of the invention are not limited in this respect. For example, when the patient returns from the exam room, the front desk staff may check to see if the current status of the patient is “Ready for Checkout.” If the patient is ready for checkout, the front desk staff member may select the patient for checkout and in response, the user interface may be configured to display checkout page 900 as illustrated in FIGS. 9A-9C.

In some embodiments, checkout page 900 includes a plurality of tabs that enable the staff to enter information into checkout page 900. In the example shown in FIGS. 9A-9C, checkout page 900 includes patient tab 910 and claim billing tab 920. It should be appreciated however, that each of the plurality of tables included on checkout page 900 may include one or multiple sections or states depending on particular tasks that the user engages in (e.g., billing, charge entry, review) and embodiments of the invention are not limited to a checkout page in which the tabs included thereon only have a single section or state.

Patient tab 910 when selected by a user, may cause the user interface to display scheduling information 912 to enable the staff to schedule a follow-up appointment for the patient or other information including referral information to enable the staff to perform other patient related tasks.

As shown in FIG. 9B, checkout page 900 may include charge entry section 914. Charge entry section 914 includes claim billing selector 916 that, when selected by a user causes the claim billing tab 920 to be selected, resulting in billing information to be displayed on the user interface as illustrated in FIG. 9C. When claim billing tab 920 is selected, charges for the patient visit that were indicated in the previous stages of the patient visit are displayed to the user for review. Once the user has reviewed the charges, the user may select the charge entry selector 922 to enter the charges.

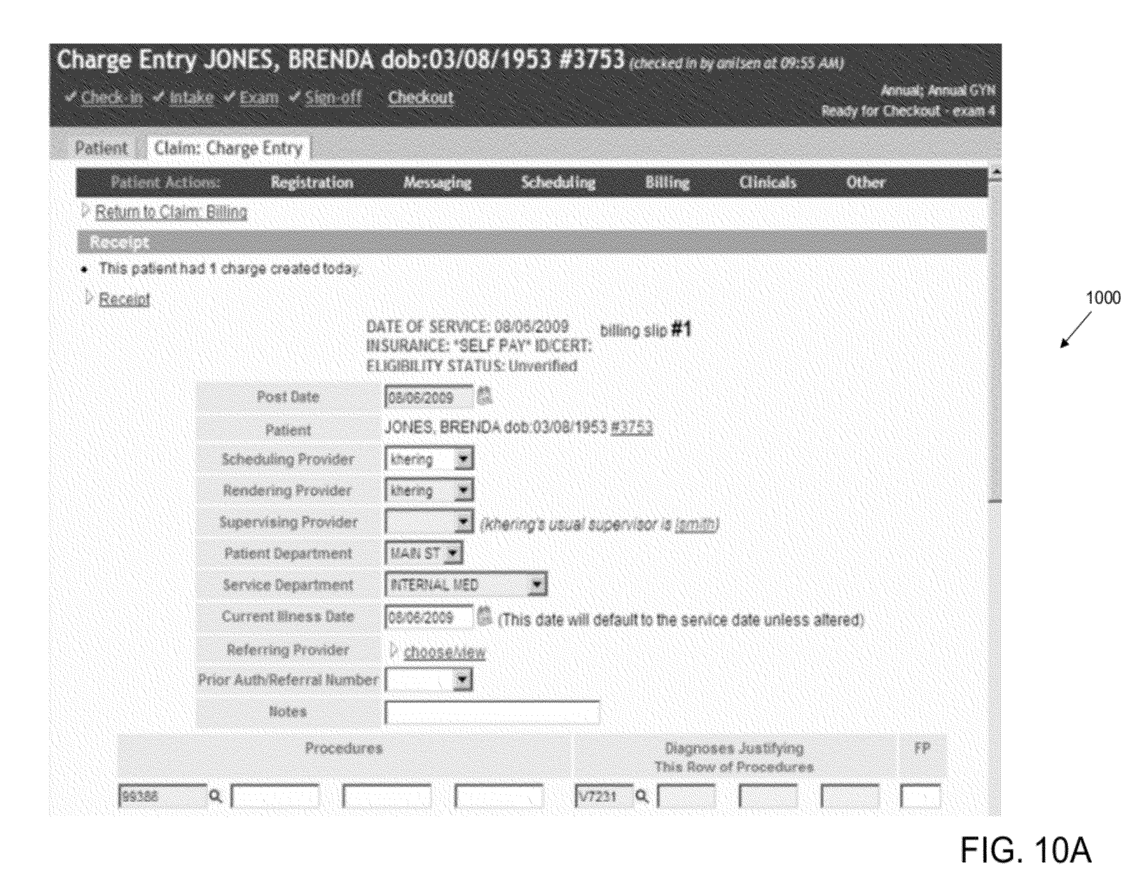

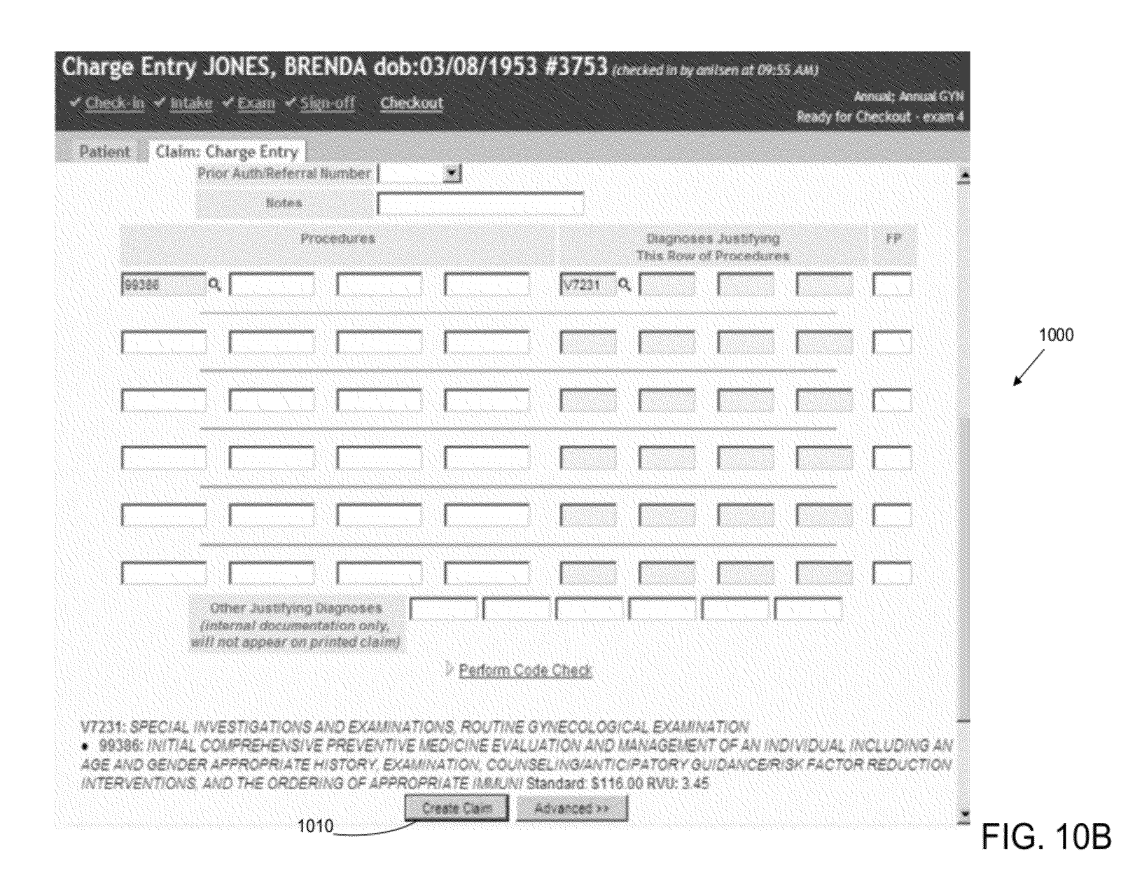

In response to the selection of charge entry selector 922, the user interface may be configured to display charge entry page 1000 as illustrated in FIGS. 10A and 10B. Charge entry page 1000 includes a plurality of fields for creating a claim based on the charges for the patient visit. At least some of the fields may be automatically filled based on information entered in the EHR system during prior stages of the patient visit. Additionally, the user may interact with one or more of the plurality of fields to edit or add more information that may be required for creation of a claim for the charge. As indicated in FIG. 10B, a user may interact with fields in charge entry page 1000 to enter one or more procedure codes and corresponding diagnosis codes justifying the procedures for the claim being created. After the user has finished entering the required information to create the claim, the user may interact with create claim selector 1010 to create the claim based on the information in charge entry page 1000.

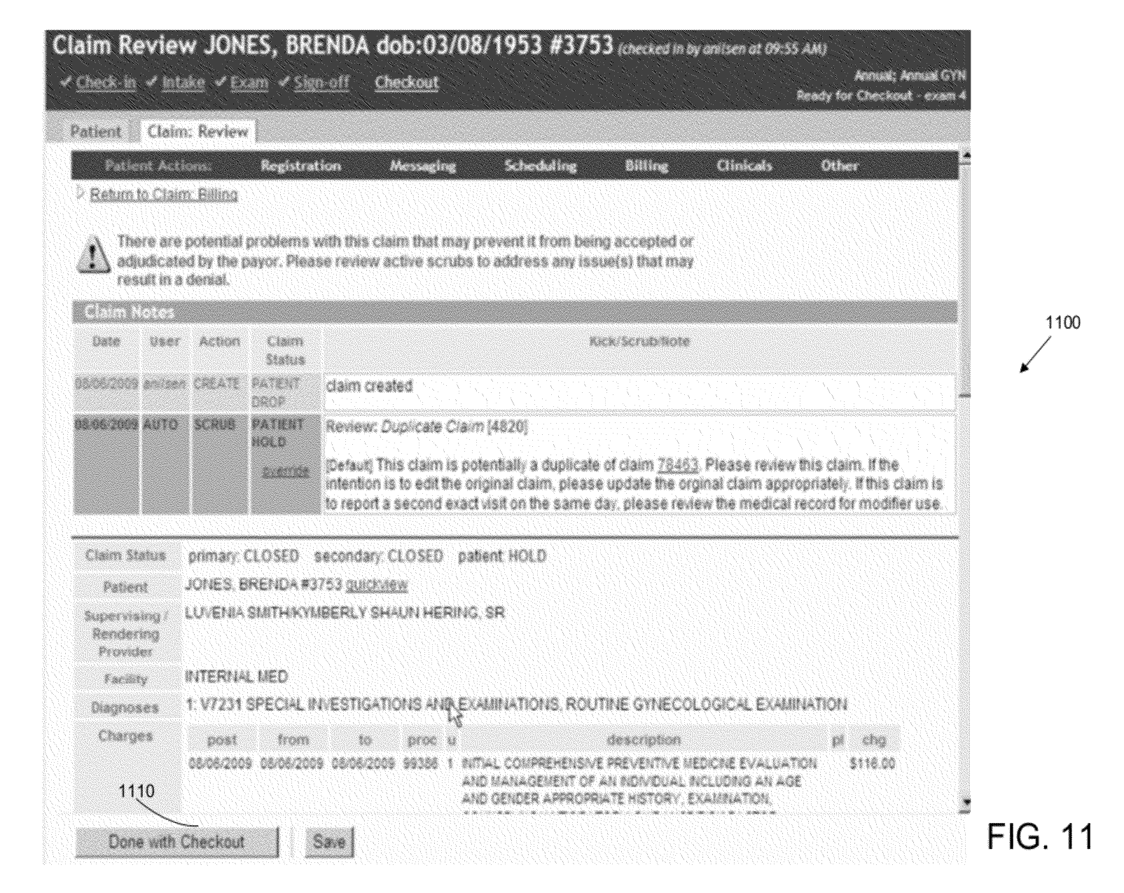

As shown in FIG. 11, in response to a selection of create claim selector 1010, the user interface may be configured to display claim review page 1100. The user may review the claim information on claim review page 1100 to ensure that the claim has been properly created. Once the user has finished creating claims representing the charges for the patient visit, the user may interact with the done with checkout selector 1110 to indicate that the checkout stage of the patient visit is complete. In response, the current status of the patient may be changed to “Complete.”

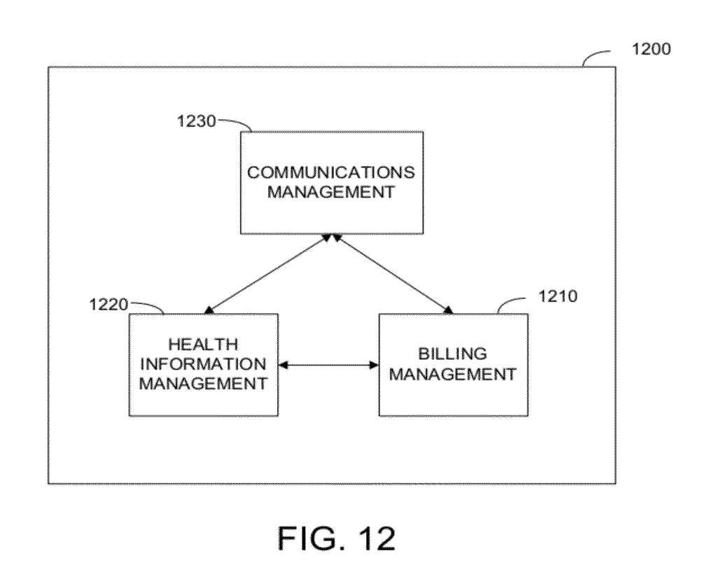

A practice management system which hosts the EHR system for the healthcare provider may analyze user performance in one or more of the stages described above to provide constructive feedback on how the healthcare provider can use the EHR system in a time-efficient manner. A block diagram of a practice management system in accordance with some embodiments of the invention is shown in FIG. 12. Practice management system 1200 may be a networked system that includes a plurality of components configured to perform tasks related to specific functions within the practice management system to facilitate the management of healthcare providers.

Exemplary practice management system 1200 includes billing management component 1210, which is configured to facilitate the collection and tracking of claims filed by the healthcare provider to a plurality of payers (including patients) to ensure that the healthcare provider is properly compensated for medical services rendered to patients treated by the healthcare provider. Practice management system 1200 also includes health information management component 1220, which is configured to store electronic health information such as the EHR data for patients of the healthcare provider. Practice management system 1200 also includes communications management component 1230, which interacts with health information management component 1220 and billing management component 1210 to automate interactions with patients on behalf of the healthcare provider. Although practice management system 1200 is only shown as having three components, it should be appreciated that practice management system 1200 may include any number of components that interact in any suitable way and embodiments of the invention are not limited in this respect. Furthermore, some or all of the components in practice management system 1200 may interact by sharing data, triggering actions to be performed by other components, prevent actions from being performed by other components, storing data on behalf of other components, and/or interacting in any other suitable way.

As discussed above, some healthcare providers may be hesitant to adopt an EHR system based, at least in part, on the perception that such systems slow down healthcare providers during patient encounters. In some embodiments, practice management system 1200 may collect data related to the amount of time that users spend in each stage of a patient visit. The collected data may be used to assess provider efficiency by identifying stages during patient visits that take the most time. Other efficiency metrics may also be determined by practice management system 1200 based on time spent entering data into the EHR system, as will be discussed in more detail below.

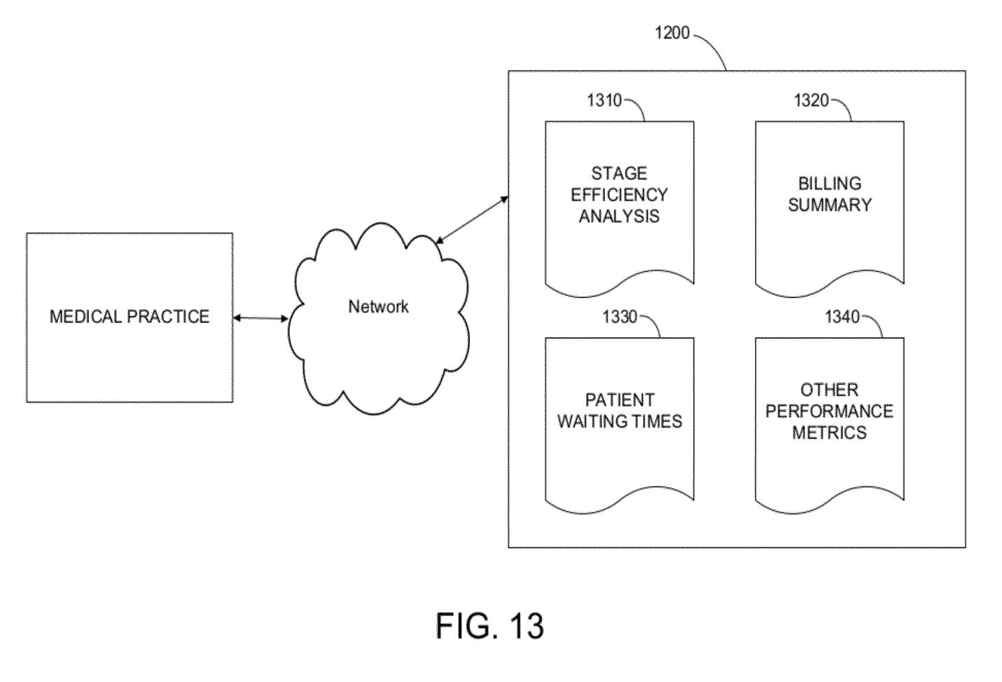

FIG. 13 illustrates a plurality of performance metrics that may be determined by practice management system 1200 based, at least in part, on tracking of patient visits to a healthcare provider in accordance with some embodiments of the invention. For example, practice management system 1200 may perform stage efficiency analysis 1310 to determine an amount of time that the healthcare provider is spending during one or more stages of a patient visit. Stage efficiency analysis 1310 may be performed in any suitable way and embodiments of the invention are not limited in this respect. For example, practice management system 1200 may determine an amount of time spent in each stage as an aggregate time when the first page of the stage is displayed to a user until the user has selected the corresponding done with stage selector. Additionally, if a user returns to a stage to make one or more modifications to the stored health information or to add new health information, the time spent after re-entering the stage may also be taken into consideration when determining time spent during each stage.

In some embodiments, practice management system 1200 may also determine a billing summary 1320 that represents an amount of time spent by users at a healthcare provider on billing-related matters including, but not limited to, charge entry. Billing summary 1320 may indicate which users (or type of users) are spending time entering billing information, and during which stage the billing information is being entered. Healthcare providers may use feedback from the practice management system 1200 to optimize workflow procedures to ensure that billing-related matters are handled in a way that is most efficient for the practice.

In some embodiments, practice management system 1200 may also determine patient waiting times 1330 based, at least in part, on the amount of time that users are entering data into the EHR system compared to the amount of time that a patient is actually at the medical practice. Identifying portions of the patient visit during which patients are waiting for significant amounts of time may be useful in helping healthcare provider's to understand how patient visit workflows may be improved. Other performance metrics 1340 may also be determined by practice management system 1200 and the other performance metrics 1340 may be provided to healthcare providers to improve patient visit workflow.

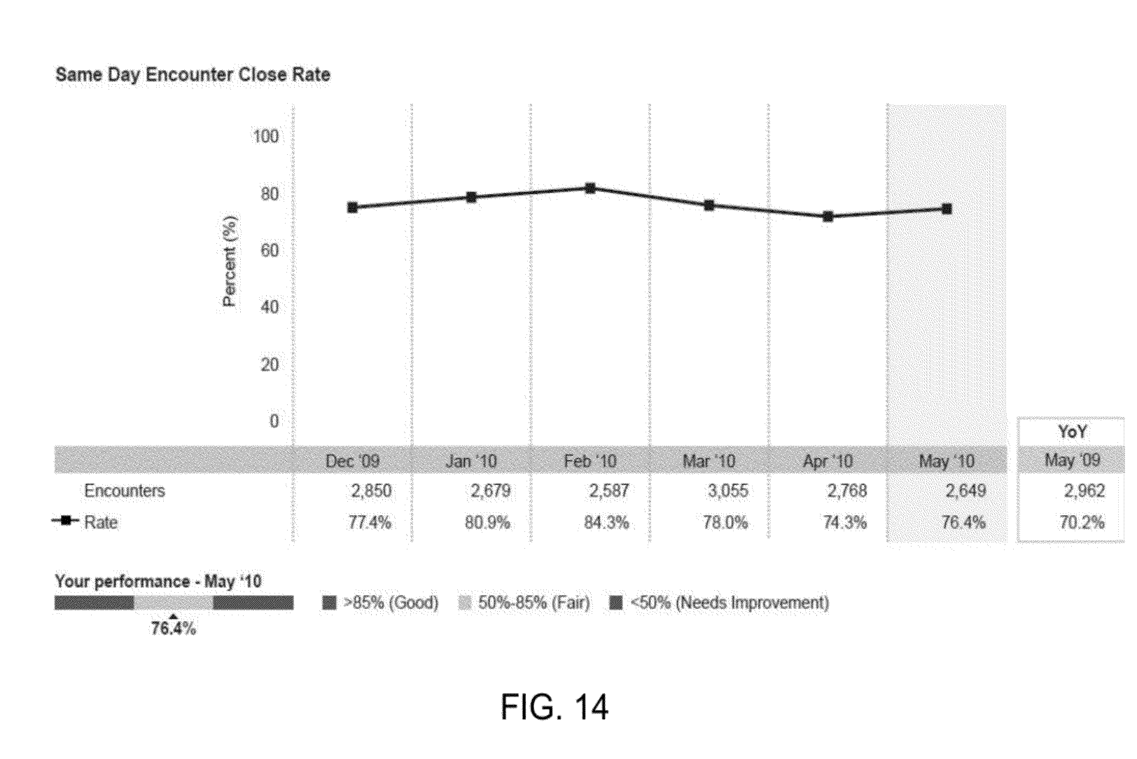

The one or more metrics determined by practice management system 1200 may be presented to a healthcare provider in any suitable way. FIGS. 14-22 illustrate exemplary reports output from practice management system 1200 that may be used by a healthcare provider to improve a patient visit workflow in accordance with some embodiments of the invention.

In some embodiments, practice management system 1200 determines how often patient encounters are closed the same day that they are created, as a delay in closing encounters may indicate a lack of efficiency in a patient visit workflow. FIG. 14 shows a summary report that provides insight into a healthcare provider's overall efficiency with respect to this metric over predetermined time intervals. The summary report may include any combination of charts, plots, graphs, and/or tables to convey the performance data determined by the practice management system.

The exemplary summary report shown in FIG. 14 includes a plot and a corresponding table of values illustrating the rate of same day encounter closes for a healthcare provider over the course of six months. By comparing the same day encounter close rate over predetermined time intervals (e.g., one month), the healthcare provider may assess whether this metric is improving, declining, or staying the same. The exemplary summary report shown in FIG. 14 also includes a year to year comparison of this metric, which may be helpful for the healthcare provider to assess changes in this metric on a longer time scale. In some embodiments, a general categorization may be assigned to the same day encounter close rate for a healthcare provider for the most recent time period. For example, the general categorization may be “Good,” “Fair,” or “Needs Improvement,” as shown in FIG. 14. The number of general categorization categories and/or cutoff values for the general categorization may be established in any suitable way including, but not limited to, expected values based, at least in part on all of the healthcare providers using the practice management system.

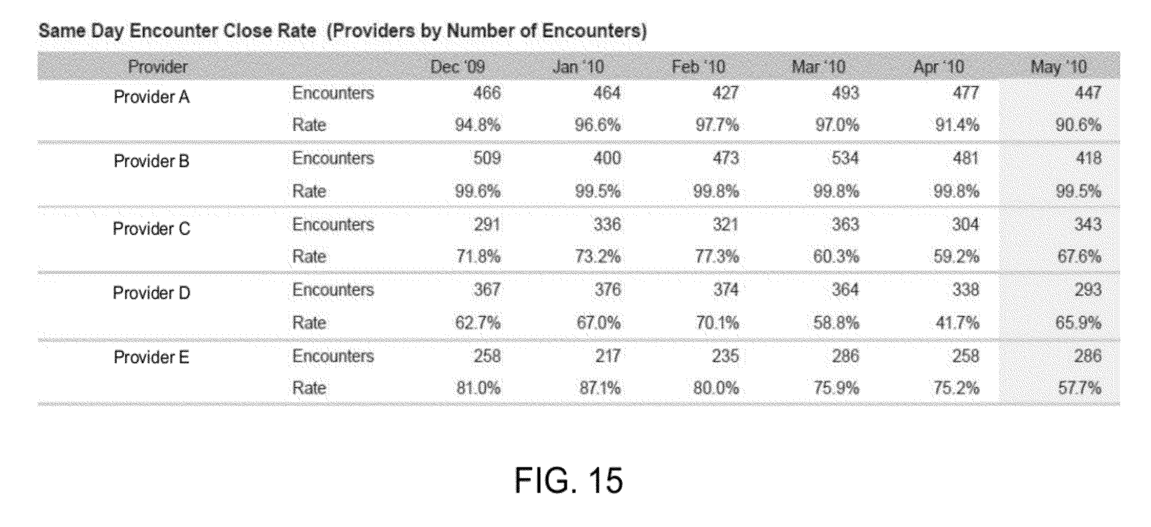

In some embodiments, the same day encounter close rate performance metric may be determined for individual healthcare providers within a medical practice. As shown in FIG. 15, the top volume providers for a medical practice may be ranked according to their associated rate of same day encounter closes. Identifying providers with high rates of same day closes may help the medical practice to improve efficiency and/or encourage providers to attain higher same day encounter close rates.

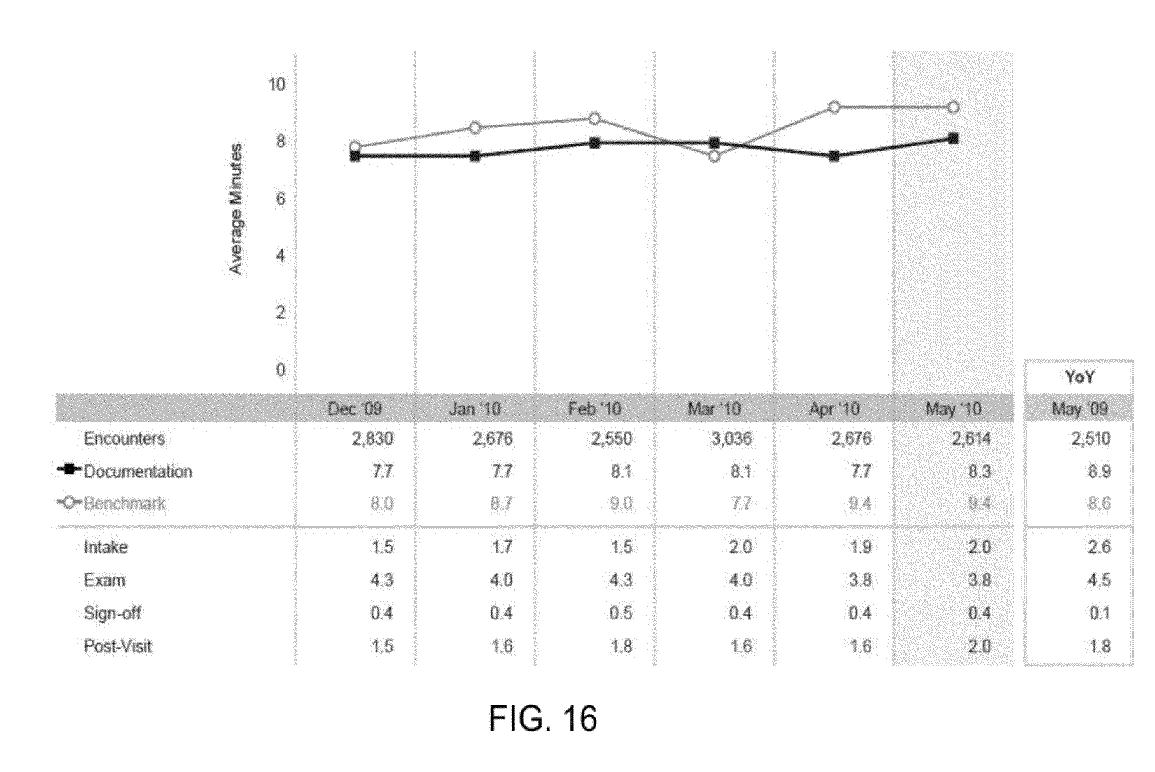

As discussed above, determining the average amount of time that users spend documenting patient encounters (e.g., entering health information into the EHR system) may highlight opportunities for healthcare providers to improve efficiency and/or delegation of tasks. FIG. 16 shows a summary report that provides insight into a healthcare provider's overall efficiency with respect to documentation time over predetermined time intervals. The summary report may include any combination of charts, plots, graphs, and/or tables to convey the performance data determined by the practice management system.

The exemplary summary report shown in FIG. 16 includes a plot and a corresponding table of values illustrating the average number of minutes that a healthcare provider spends documenting a patient encounter. By comparing the average time documenting a patient encounter overall and per one or more stages for the patient visit over predetermined time intervals (e.g., one month), the healthcare provider may assess whether this metric is improving, declining, or staying the same. The exemplary summary report shown in FIG. 16 also includes a table of values that divides the total time spent documenting a patient encounter based on one or more of the plurality of stages for the patient encounter, as described above. A year to year comparison of documentation time is also included, which may be helpful for the healthcare provider to assess changes in this metric on a longer time scale.

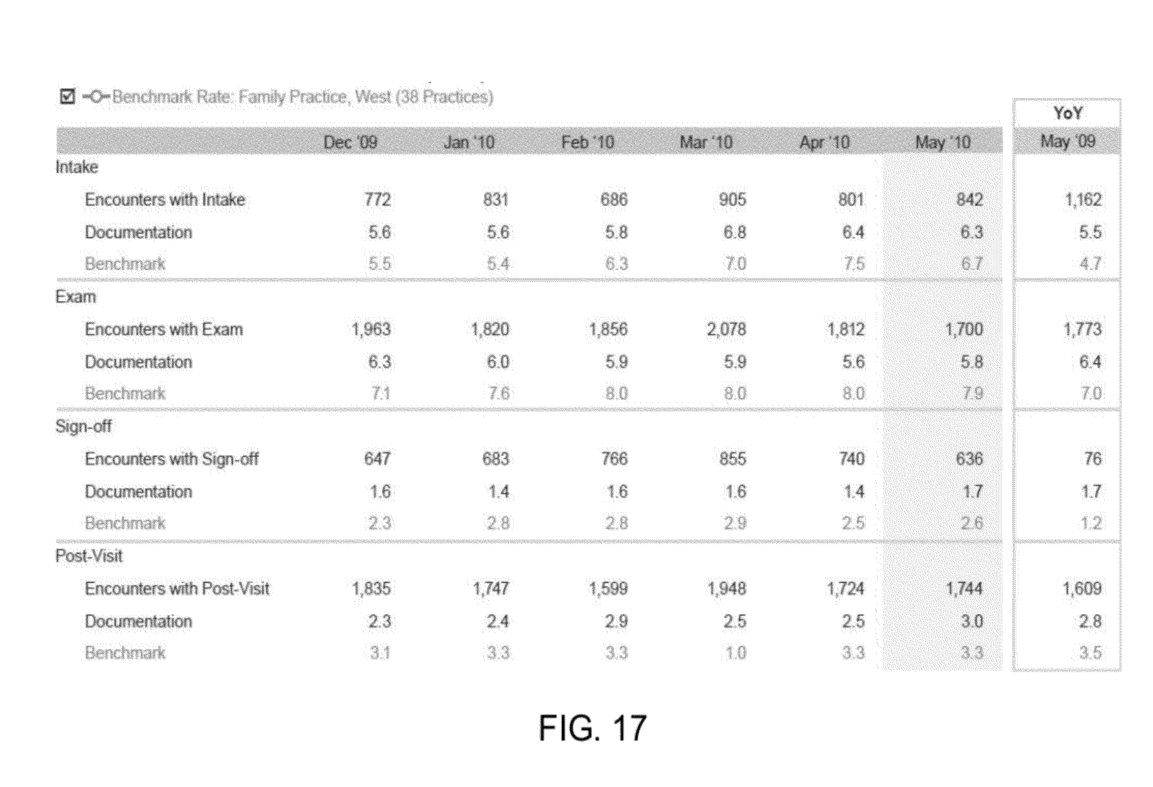

FIG. 17 shows an exemplary documentation time report that enables healthcare providers to view the average time spent during specific patient visit stages and after the visit has been completed (post-visit). The documentation time for each stage may be compared over multiple time periods of any suitable length. Documentation times for each provider or medical practice may also be compared against benchmark data to enable the provider or practice to evaluate their efficiency in relation to average documentation times for other providers or practices.

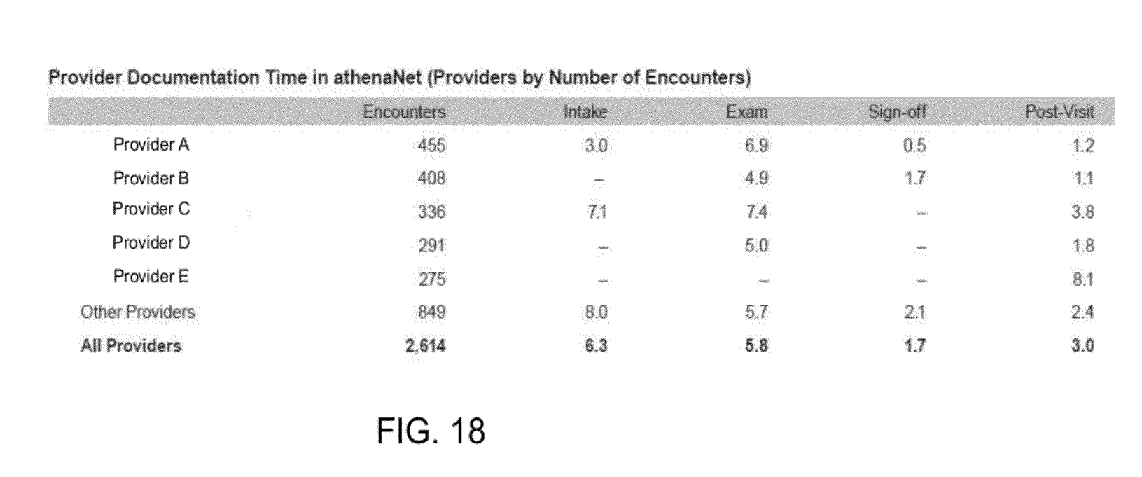

In some embodiments, the documentation time performance metric may be determined for individual healthcare providers within a medical practice. As shown in FIG. 18, the top volume providers for a medical practice may be ranked according to their number of patient encounters and the average amount of time that each provider spent documenting per stage may be reported. Identifying providers with lower documentation times may help a medical practice to improve efficiency.

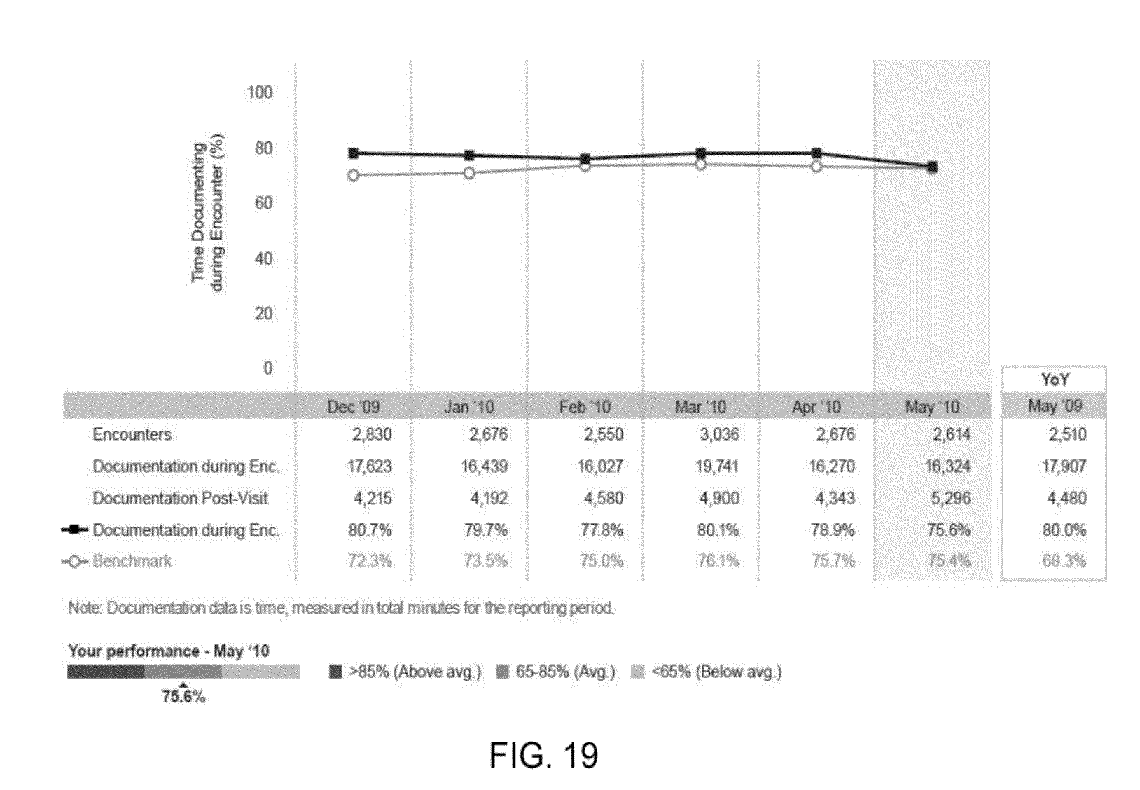

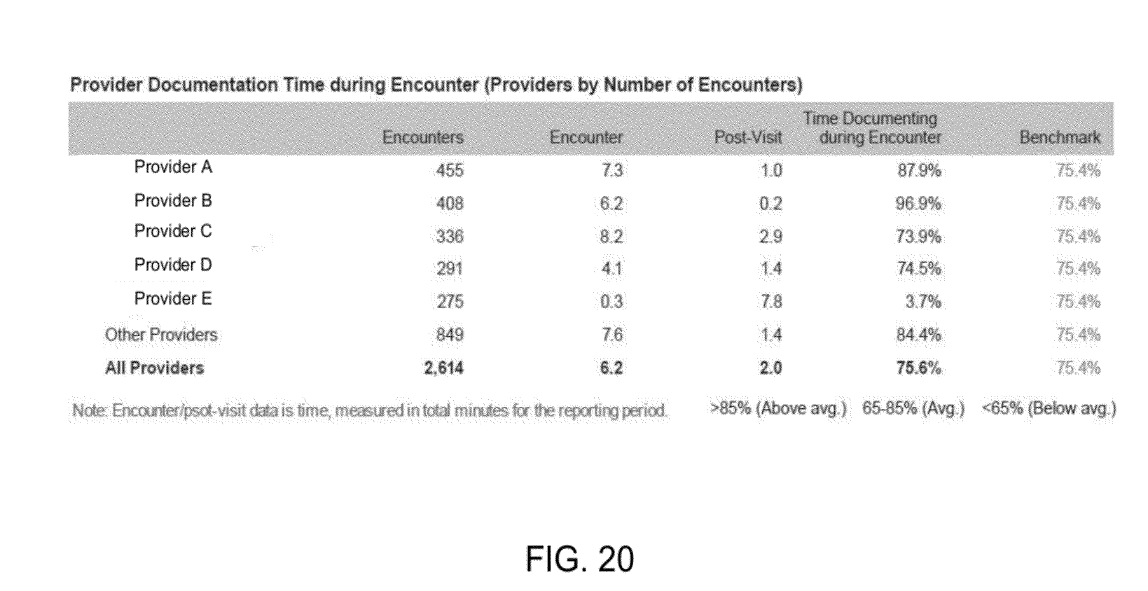

In some embodiments, the time spent documenting health information during patient encounters may be determined, as completing a higher percentage of encounter documentation before the patient visit has completed their visit may be used as an indication of provider efficiency. FIG. 19 illustrates an exemplary report including a graph and corresponding table that describes the amount of time spent documenting health information during patient visits to a medical practice. The table displayed in FIG. 19 provides values for the total amount of time spent documenting during patient visits and after patients have completed their visits. Providers in a medical practice with the highest number of patient encounters may also be identified the amount of time each provider spent documenting during patient visit stages and after a patient visit may be included in a report as illustrated in FIG. 20.

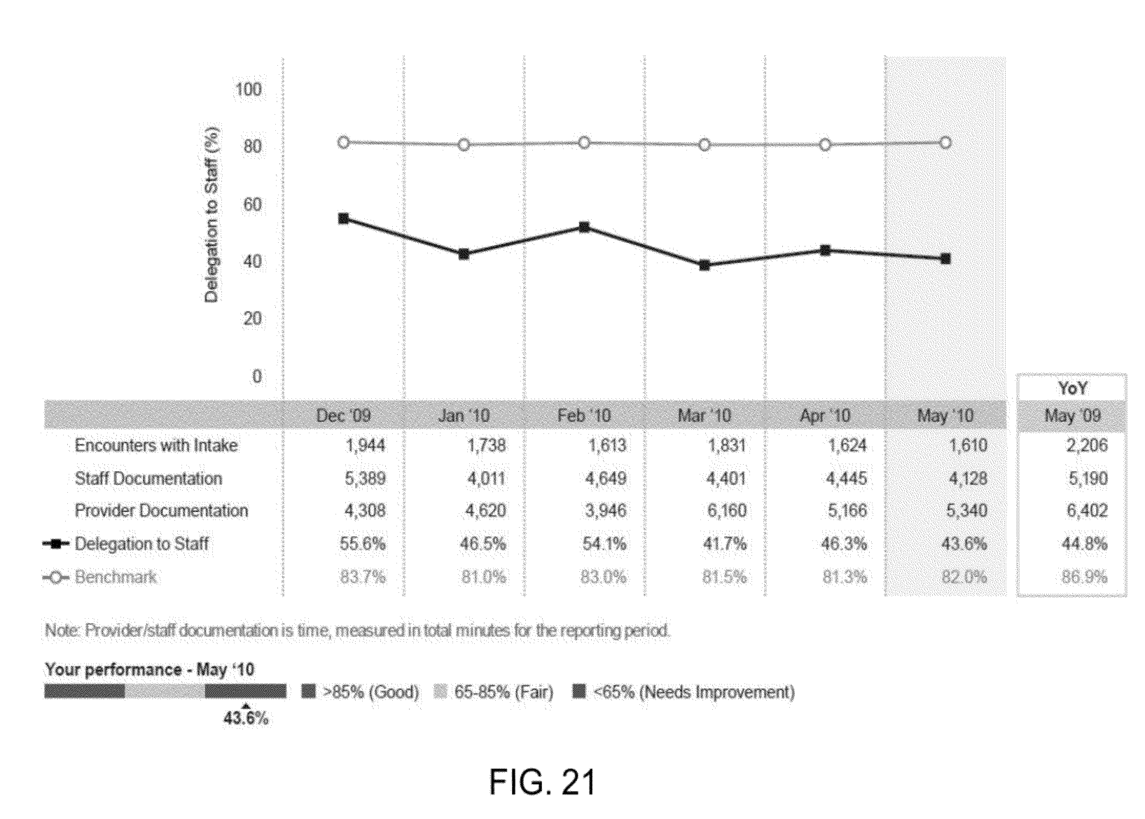

Delegation of intake documentation to practice staff may be an important part of increasing the efficiency and productivity of healthcare providers. Accordingly, as shown in FIG. 21, the practice management system may generate a report that tracks how effectively the provider or practice is delegating intake by comparing the documentation time of practice staff and providers during the intake stage. FIG. 21 illustrates an exemplary report that includes a graph and a corresponding table representing values for the total time spent entering health information for staff and providers during the intake stage. The percentage of delegation to staff is reflected by the ratio of staff to provider documentation. The delegation to staff metric may be determined over short time intervals (e.g., weeks or months) or longer intervals (e.g. years) to enable the healthcare provider or practice to track the progress of changes in this efficiency metric. A provider or practice's delegation to staff metric may also be compared to benchmark data to enable the healthcare provider or practice to determine how their delegation procedures compare to other practices.

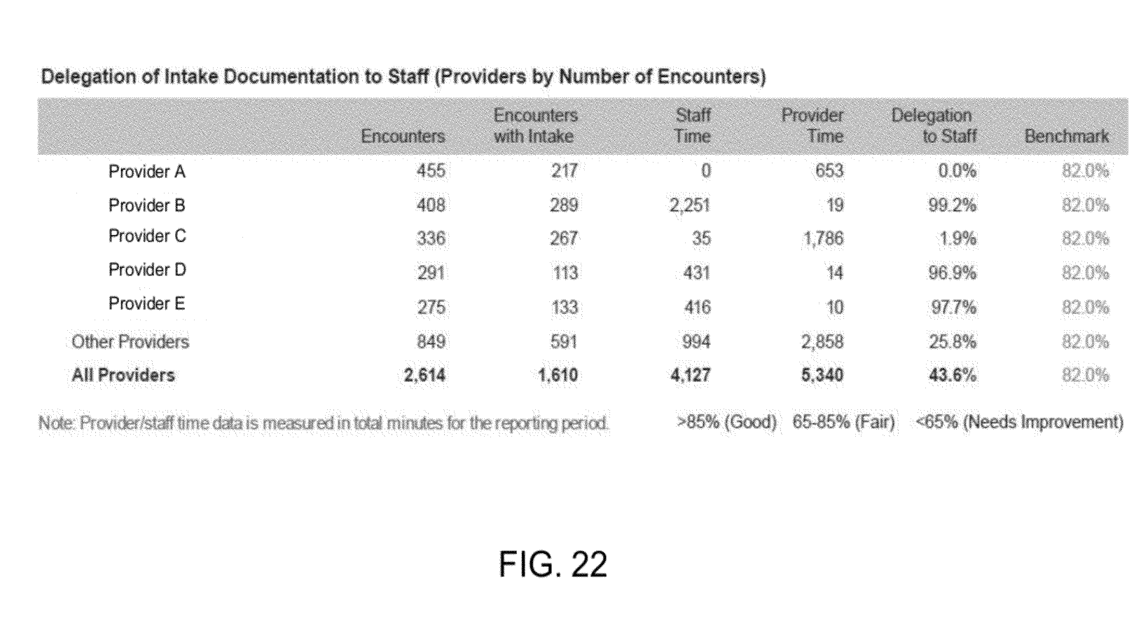

In some embodiments, the delegation to staff performance metric may be determined for individual healthcare providers within a medical practice. As shown in FIG. 22, the providers with the highest number of patient encounters for a medical practice may be displayed in a report to indicate how well the provider delegates intake documentation procedures to their staff within the medical practice. Providers that delegate intake documentation tasks less to staff may be encouraged to do so in an effort to increase the efficiency of the medical practice.

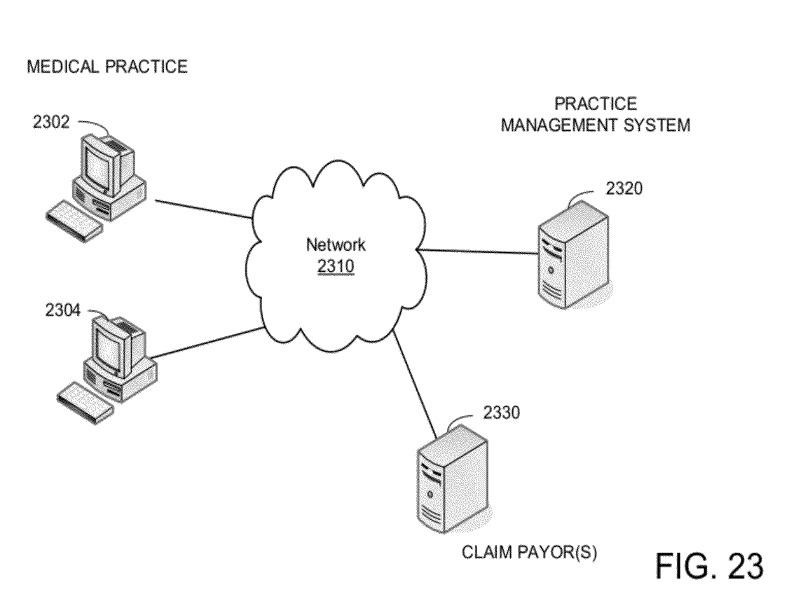

FIG. 23 illustrates an exemplary networked system on which some embodiments of the invention may be employed. Networked computers 2302 and 2304 located at a medical practice, claim payor computer 2330, and computer 2320 located at a location associated with a practice management system are shown connected to a network 2310. Network 2310 may be any type of local or remote network including, for example, a local area network (LAN) or a wide area network (WAN) such as the Internet. In the example of FIG. 23, four networked computers are shown. However, it should be appreciated that network 2310 may interconnect any number of computers of various types and the networked system of FIG. 23 is provided merely for illustrative purposes. For example, computer 2320 may be connected via network 2310 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of facilitating collection of information during a patient visit to a healthcare provider, the method comprising:
associating each of a plurality of tasks with a plurality of stages of the patient visit; and
guiding at least one user through one or more of the plurality of stages of the patient visit to complete the plurality of tasks during the patient visit, wherein guiding the at least one user comprises:
displaying on a user interface, at least one page for collecting the information during the patient visit; and
receiving input entered by the at least one user, wherein the input corresponds to the information.

2. The method of claim 1, further comprising:
determining for at least one patient visit, an amount of time that the at least one user spends entering data during at least one of the one or more of the plurality of stages of the at least one patient visit.

3. The method of claim 2, wherein the at least one patient visit comprises a plurality of patient visits, wherein the method further comprises:
determining an average amount of time that the at least one user spends entering data during at least one of the one or more of the plurality of stages for the plurality of patient visits.

4. The method of claim 3, further comprising:
creating at least one report indicating that average amount of time; and
displaying the at least one report on the user interface.

5. The method of claim 3, further comprising:
modifying at least one patient visit workflow based, at least in part, on the average amount of time that the at least one user spends entering data during at least one of the one or more of the plurality of stages for the plurality of patient visits.

6. The method of claim 1, wherein the plurality of stages includes check-in, intake, exam, sign-off, and checkout.

7. The method of claim 1, wherein the plurality of stages includes an exam stage, wherein the method further comprises:
tracking an amount of time that the at least one user spends entering the information during the exam stage.

8. The method of claim 1, wherein the information includes health information and billing information.

9. The method of claim 1, wherein the plurality of tasks includes a charge entry task and the plurality of stages includes a checkout stage, wherein the method further comprises:
associating the charge entry task with the checkout stage to enable the at least one user to perform charge entry during the checkout stage.

10. The method of claim 1, wherein guiding the at least one user through the one or more of the plurality of stages of the patient visit further comprises:
providing an indication to the at least one user that at least one of the one or more of the plurality of stages has been completed.

11. The method of claim 1, further comprising:
updating, on the user interface, a patient status indicator based on the current stage of the plurality of stages.

12. At least one computer-readable medium encoded with a plurality of instructions that, when executed by a computer, perform a method comprising:
associating each of a plurality of tasks with a plurality of stages of a patient visit; and
guiding at least one user through one or more of the plurality of stages of the patient visit to complete the plurality of tasks, wherein guiding the at least one user comprises:
displaying on a user interface, at least one page for collecting information during the patient visit; and
receiving input entered by the at least one user, wherein the input corresponds to the information.

13. The at least one computer-readable medium of claim 12, wherein the method further comprises:
determining for at least one patient visit, an amount of time that the at least one user spends entering data during at least one of the one or more of the plurality of stages of the at least one patient visit.

14. The at least one computer-readable medium of claim 13, wherein the at least one patient visit comprises a plurality of patient visits, wherein the method further comprises:
determining an average amount of time that the at least one user spends entering data during at least one of the one or more of the plurality of stages for the plurality of patient visits.

15. The at least one computer-readable medium of claim 14, wherein the method further comprises:
creating at least one report indicating that average amount of time; and
displaying the at least one report on the user interface.

16. The at least one computer-readable medium of claim 12, wherein guiding the at least one user through the one or more of the plurality of stages of the patient visit further comprises:
providing an indication to the at least one user that at least one of the one or more of the plurality of stages has been completed.

17. The at least one computer-readable medium of claim 12, wherein the method further comprises:
updating, on the user interface, a patient status indicator based on the current stage of the plurality of stages.

18. A computer system configured to enable at least one user to enter information for a patient during a patient visit to a healthcare provider, the computer system comprising:
at least one processor programmed to:
associate each of a plurality of tasks with a plurality of stages of the patient visit; and
guide the at least one user through one or more of the plurality of stages of the patient visit to complete the plurality of tasks, wherein guiding the at least one user comprises:
displaying on a user interface, at least one page for collecting the information during the patient visit; and
receiving input entered by the at least one user, wherein the input corresponds to the information.

19. The computer system of claim 18, wherein the at least one processor is further programmed to:
determine an average amount of time that the at least one user spends entering data during at least one of the one or more of the plurality of stages for a plurality of patient visits.

20. The computer system of claim 19, wherein the at least one processor is further programmed to:
create at least one report indicating that average amount of time; and
display the at least one report on the user interface.

21. A method of evaluating an efficiency of a patient visit workflow for at least one medical practice, the method comprising:
determining an amount of time spent documenting information during at least one of one or more of a plurality of stages of a patient visit; and
determining at least one performance metric for the at least one medical practice based, at least in part on the determined amount of time spent documenting information.
